(19) United States
(12) Patent Application Publication
(10) Pub. No.: US 2006/0001545 A1
(43) Pub. Date: Jan. 5, 2006

(54) Non-Intrusive Fall Protection Device, System and Method

(75) Inventor: Brian Wolf, Brattleboro, VT (US)

Correspondence Address: LAW OFFICE OF JAY R. YABLON, 910 NORTHUMBERLAND DRIVE, SCHENECTADY, NY, 12309-2814, US

(73) Assignee: Mr. Brian Wolf, Brattleboro, VT (US)

(21) Appl. No.: 10/908,251

(22) Filed: May 4, 2005

(51) Int. Cl. G08B 23/00; G08B 21/00

(52) U.S. Cl. 340/573.1; 340/686.1

(57) ABSTRACT

Disclosed herein is a fall protection system and related method comprising a sensor; a computerized device receiving detections from the sensor, for deducing fall conditions from the body of a person to be protected, indicating that the person is beginning to fall; and at least one cushion not carried with the person, for deployment at at least one projected impact location where it is projected that impact from the fall will occur, for reducing a force of the impact, in response to detecting fall conditions. Also disclosed is a flooring system and related method which changes from a hard state to a cushioned state upon receiving a signal to effectuate said change, comprising: a floor surface; a cushioning material beneath said floor surface; a hard floor support for maintaining said floor in said hard state during normal use; and a hard floor support release for releasing said at least part of said hard floor support responsive to receiving said signal, such that once said hard floor support is removed, said floor becomes supported by said cushioning material.

### FIELD OF THE INVENTION

This invention relates generally to protecting humans from injury and death due to falls, and in particular, relates to non-intrusive devices and methods to detect the onset of a fall and deploy fall protection devices in response thereto.

### BACKGROUND OF THE INVENTION

Seniors 65 and over are five times more likely to have a fall-related injury than any other injury. In the U.S., ⅓ to ½ of people over age 65 will experience some kind of fall in any given year and 9,500 of them will die as a result. The elderly represent more than one third of all hospital injury admissions, and more than 80% of these injuries are caused by falls. Consequences of serious falls include death, substantial medical expenses, loss of independence, or having to move into a nursing home. One in eight people in the US is age 65 or over. And the age 85 and over group is the fastest-growing group. Hospital stays are usually twice as long as those from non-fall injuries. 60% of all falls occur in private homes (see American Academy of Orthopedic Surgeons, http://orthoinfo.aaos.org/fact/thr_report.cfm?Thread_{—ID=}74&topcategory=Prevent%20Falls&all=all). 60% of nursing home residents are prone to fall. FIG. 24 shows vividly, the degree to which seniors are much more prone to death by falling than any other age group.

Looking toward the future, more than 80% of all people in the U.S. aged 45 to 65, the “Baby Boomers,” would like to stay in their current home and never move. More than 30% of this over-age-45 group are worried they will have problems living at home and will have to enter a nursing home.

The psychological effects of a fall can be as damaging as well. About one third of seniors who fallen once have a persistent fear of falling again. This can be as debilitating as the fall itself (Vellas, B. J., Wayne, S. J., Romero, L. J., Baumgardner, R. N., Garry, P. J., Fear of Falling and Restriction of Mobility in Elderly Fallers, Age & Aging 26(3) 189-193, (1997b)). Seniors in this situation may restrict themselves from activities that may lead to more falls, with a consequent loss of quality of life (Tinette, M. E., Williams, C. S. Falls, injuries due to falls, and the risk, New England Journal of Medicine 337(18) 1279-84 ((1997))). It has been shown that fear of falling can compound balance control problems, such that the actual fear leads to increased postural sway, and hence the likelihood of falls is actually increased (Adkin, A., Carpenter, M. G., Frank, J. S., Balance confidence modifies postural control, in press).

On top of al this are the economic costs. In the U.S. the direct cost of falls was $20.2 billion in 1994. This figure is expected to rise to more than $43 billion in 2020 and some studies suggests this will climb to over $240 billion by 2040. Potentially larger are looming nursing home costs which are expected to soar with the “graying” of the “Baby Boomers.” If people can comfortably live at home, fewer burdens will be placed on the nation's healthcare and insurance system to support them and the new generation of seniors can maintain their highly desired independence for a longer period of time and remain contributing members of society.

The potential impact of this major health issue is considered significant enough with regard to the overall health of the American public, and the economic welfare of the Medicare and Medicaid programs, that it is the subject of a bill currently before the Congress. On Nov. 18, 2003, Representative Frank Pallone (D-NJ) introduced H.R. 3513, the Elder Fall Prevention Act. The bill would: 1) establish public and professional education programs on ways of reducing the risk of elder falls, and preventing repeat falls; 2) provide grants to qualified organizations to carry out educational programs; and 3) direct the Secretary of Health and Human Services to expand and intensify research and related activities concerning elder falls.

Falling is not limited to the elderly. At the other end of the age spectrum, healthy young people who engage in large amounts of diverse and physically challenging tasks have a disproportionate amount of fall events (Koski, Luukinen, Laippala, Kivela, Risk Factors for major injurious falls among the home dwelling elderly, Gerontology 44(4) 232-8 (1998)). Thus, it is also important to address these at risk groups, as well as children, especially at playgrounds.

Figures alone cannot convey the suffering of fall victims and their families. People now have the unprecedented opportunity to live longer, healthier lives. Nevertheless bones and skeletal structure will invariably become fragile, no matter what dietary adjustments are made. It is tragic for an older person who has worked hard to maintain good health, is living independently and continues to have enthusiasm for life, to lose his or her independence or even life from an accidental fall.

The prior art discloses various systems for protecting people against impacts in other situations. Most notable, of course, are automotive airbag systems. In these systems, sensors detect that the vehicle itself is experiencing an impact, and in response thereto, airbag cushions are deployed to soften the impact of people in the vehicle with the vehicle interiors, e.g., dashboard, steering wheel, etc.

Compliant (foam cushioned) ground surfaces have been shown to reduce forces associated with wrist injuries in forward falls, and to a lesser extent, associated secondary forces associated with shoulder injuries (Maki, McIlroy, Fernie, Change-in-Support Reactions for Balance Recovery, IEEE Engineering in Medicine and Biology Magazine, March/April 2003). The force attenuation properties of the foam cushion are inversely dependent on surface stiffness. A drawback to a soft foam system is that there are practical limit to decreases in surface stiffness (increasing foam cushion thickness). Another drawback is the effect decreasing surface stiffness would have on walking stability, especially for fall-prone elderly who may suffer from gait and balance abnormalities.

U.S. Pat. No. 5,500,952 discloses a system wherein both a cushion and a sensor are mounted on the person to be protected. A number of hip padding systems exist providing varying levels of protection (Robinovitch, S. N., McMahon, T. A., and Hayes, W. C., Energy shunting hip padding system improves femoral impact force attenuation in a simulated fall. Journal of Biomechanical Engineering 117:409-413 (1995)). Carrying around a cushion or pad in this manner, and/or sensors, however, is inconvenient, and protection is only provided to the person carrying such a system, and not to anybody else. Also, such a system only provides protection to the part of body covered, in this case the hip, when in fact other serious injuries or trauma to the wrist, vertebrae, or head may occur as a result of a fall.

Indeed, there is much to be gained from novel and inventive ways to apply to fall protection, extensive research and experience in the deployment of airbags in cars. Especially of interest are system in which sensors are used to prevent injury from impact by detecting or imaging a person prior to deployment of a cushioning device. For example, after airbags were initially deployed in cars for protection of passengers during a crash, serious injuries were found to be occurring, particularly to children because of their smaller size. Consequently, methods were developed for sensing the size and position of occupants, and also their presence or absence, and also the presence of items which may cause injury. Systems such as disclosed in U.S. Pat. No. 6,513,833 detect the presence of occupants, their positions, i.e., determine if they are out-of-position, and their types, e.g., to identify the presence of a child and/or a rear-facing child seat. A child in a rear-facing child seat, which is placed on the right front passenger seat, is in danger of being seriously injured if the passenger airbag deploys. This has now become an industry-wide concern and the U.S. automobile industry is continually searching for an easy, economical solution, which will prevent the deployment of the passenger side airbag if a rear facing child seat is present. Inflators now exist which adjust the amount of gas flowing to or from the airbag to account for the size and position of the occupant and for the severity of the accident. The vehicle identification and monitoring system (VIMS) (U.S. Pat. Nos. 5,829,782, and 5,943,295) controls such inflators based on the presence and position of vehicle occupants or a rear facing child seat. Sensing takes place using direct ultrasonic ranging sensors, optical ranging sensors, radar ranging sensors, optical tracking sensors or combinations thereof. Further refinement in the adaptation to specific makes and models of cars as well improvements in the pattern recognition algorithm are also of interest.

In the literature, a fall is understood to be an unintentional event that results in a person coming to rest on the ground or another lower level (Kellogg International Working Group on the Prevention of Falls by the Elderly, 1987). Falls are usually distinguished from “near falls” where a successful recovery has been made.

There are five activity states during which a person may experience a falling event: walking, climbing, standing, sitting, and prone (from bed, etc.). Types of falls or near falls include forward, backward, and sideways. In each of these cases, the fall behavior is different. In forward falls, people tend to land on hands and knees. Sideways falls are usually associated with a larger truck rotation that does not occur in forward or backward falls. Backward falls are often characterized by a landing on the buttocks, with resultant risks of spinal and pelvic injury. (Rabinovich, S. N., Hsiou E. T. et al., Prevention of Falls and Fall Related Fractures through Biomechanics, Exercise and Sport Science Reviews, Vol 8 No 2 (2000).) Though initial impact of forward and sideways falls is often on hand, knees, etc., there is often a secondary impact to the head.

Kinetic analysis has been employed, in some circumstances, to detect falls (Bourke, A., Lyons, G. M., Culhane, K., et al. Fall Detection in the Elderly Using Accelerometry, AAATE, Dublin (2003)). Computer vision systems employing a biomechanical human model have been used for human gait identification (Wagg, D. K. and Nixon, M. S., Automated Model-Based Extraction and Analysis of Gait, Proceedings of 6th International Conference on Automatic Face and Gesture Recognition, pages pp. 11-16, Seoul, South Korea. Azada, D., Eds. (2004)). Forces and accelerations at specific points of the body can be calculated from the model and used as input to the fall detection model (Bourke) replacing worn accelerometers on the body with measurements extracted from video (or laser, radar, ultrasound) imaging, as is discussed further herein.

Another method of fall detection is employ only relative positions, velocities, and accelerations of parts of the body with respect to each other. This could be accomplished with one or more strain gauge devices embedded in a garment. The strain gauges measure joint flexion and, monitoring their output, supply information for detecting a fall or stumbling event. Such devices are resistive gauges that increase receptivity upon elongation. This elongation is caused by joint bending or muscle flexing. One way to detect the change in receptivity is to employ a standard Wheatstone bridge circuit, the output of which is input into an analog-to-digital converter and into the logical circuitry for analysis. Sudden rotations of the shoulders relative to the pelvis, sudden or unusual movements of the legs can be detected. In this embodiment, classes of normal gait are defined based strictly upon motions of the parts of the body relative to the rest of the body. As will be disclosed, it becomes helpful in this light to consider defining classes of relative motion related to falling. These may, for example, be gained from falling “crash tests” as disclosed later herein. Standard pattern recognition techniques may also be applied to what is detected in relation to the class definitions. Absolute motions obtained by the addition of accelerometers in the garment or attached to the body by other means, may also be considered.

For falls that occur during walking, gait signal analysis may be applied, because a fall or near fall does not have a gait signature of normal movement. The six primary determinants of human gait (Inman, V. T. et al., Human Walking, Rose and Gamble. ed., Williams & Wilkins, Baltimore, Md. (1981)) are as follows: pelvic rotation about a vertical axis, pelvic tilt in frontal plane, knee flexion in stance phase, ankle mechanism, foot mechanism, and lateral displacement.

Kinematic gait analysis measures the geometry of movement of a human or animal without consideration of the forces that cause the movement. Currently kinematic evaluations are done non-invasively using videographic or optoelectronic methods. Kinetic gait analysis directly measures the forces involved in human or animal locomotion and involves the use of strain gauges, piezoelectric transducers, and accelerometers.

Kinematics has utilized attached markers on humans and animals to track and analyze from the video recording, for instance, motion on a treadmill. As an example of gait analysis, illustrated in FIG. 25, one may analyze the shin and thigh, where ‘a’ is the angle between them, and ‘b’ is the angle of the thigh with the horizontal. The gait cycle is the time interval between two steps. The time series of these angles can be considered a unique signature gait of an individual. Various harmonic analysis and pattern recognition algorithms may then be applied to recognize the individual gait of individuals, or gait of groups (i.e., normal versus pathological, male or female, clumsy or agile). These are classes that are relevant to detecting propensity to falling, pre-fall conditions, or falling itself, each of which might be a definable class that could be discriminated from normal movement from these measurements.

One area of application of human gait analysis is biometric, so that individuals can be identified at a distance when other biometrics are not available. Another is to identify certain diseases that might affect gait, such as Parkinson's, or MS. Standard movement patterns have been identified for non-pathological individuals, and based on this, those with pathological gaits can be differentiated. (Nixon, et al.)

Additionally, human falling or near fall while walking, where the system has been trained to recognize a normal walking signature, will presumably yield a signature other than that of normal walking. For instance, a sudden lateral step is shown to be a good predictor of the onset of a fall or near-fall (Maki, McIlroy, Fernie, Change-in-Support Reactions for Balance Recovery, IEEE Engineering in Medicine and Biology Magazine (March/April 2003)). So human gait recognition methods are directly applicable to detecting a fall while walking.

Falls in conscious individuals are normally preceded by some type of compensatory motion related to control of balance (change in support reaction). For example, a compensatory step is shown to occur in half the time as a volitional step. A lateral step after taking a forward step was shown to be a predictor of lateral falls. Movement of the arms and upper torso is also a change in support reaction that may also be relevant to falls from a sitting position as well as standing. (Maki et al.) These movements can be distinguished from voluntary movement, such as bending over. Additionally, there are age-related changes in this behavior. Particularly, it takes an older person longer to initiate this behavior (Maki et al).

These motions indicate the onset of a fall of near fall. If these motions are detected, they can give an additional level of confidence for a computer vision system. For instance, increasing the level of joint stiffness and damping are shown to be the normal reaction for regaining balance for recoverable falls. Among other options, one may consider employing a neural net-based learning algorithm to establish fall or near-fall patterns.

Scene analysis based on computer vision systems is also a highly-evolved art with roots in robotics. (Duda, R. O. and Hart, P. E., Pattern Classification and Scene Analysis, John Wiley & Sons, Inc. (Jun. 1, 1973)). Such systems can be used for detection of furniture or other objects that may create obstacles to the line of vision of the camera system. For fall detection, this may be applied for proper monitoring of the protected area. The system could also monitor for commonly walked routes and then monitor for objects in the room that may cause obstruction hazards to walking.

Other efforts to place greater intelligence into the home environment for the elderly may integrate well with the fall protection system disclosed here. A large focus of these efforts is for tracking and recording human movements to provide a more responsive environment. For instance, systems exist to remind people with mild Alzheimer's disease to do routine tasks they may have forgotten to do. Intel's large scale effort in this area is called “Proactive Health,” within this framework it has a project referred to as “Aging-In-Place” (see http://www.intel.com/research/prohealth/cs-aging_in_place.htm.)

As another example of efforts made to place more intelligence into the home environment that would integrate well with the system to be disclosed here, Infineon corporation has developed the “smart carpet” (see http://www.infineon.com/cgi/ecrm.dll/jsp/showfrontend.do?lang=EN&news_nav_oid=-9979&content_type=NEWS&content_oid=76718) The Infineon demonstrator incorporates robust encapsulated integrated capacitive sensors that act as touch detectors and LEDs which act as display elements. A carpet equipped with these chips and with this electronic architecture can thus be used as a motion detector. The more densely the sensor elements are arranged, the more precise the results of measurement. At the same time, the integrated LEDs support use of the high-tech carpet as a control system that can be used in the home to mark safe walking routes around obstacles. The LED network placed on the floor could also be used, for example, as an additional testing system for the video camera detection system disclosed here. For instance, if certain LED's are flashing, and are not registered by the cameras, then it may indicate that the camera system is not working or that there are obstacles to its field of vision, or new obstacle hazards to walking.

Also, widely-used methods to detect pathological gait may be applied to fall detection. A data set of normal walking and falling movement can be generated from test subjects, and be used, using pattern recognition, to detect the onset of a fall, i.e., falling or near fall, as a form of pathological gait.

Recognizing the expense that may be entailed in deploying a non-intrusive fall protection system, it is helpful to identify those groups of elderly who would most benefit from using such a system, including, but not limited to, those identified as prone to falling or as particularly vulnerable to a fall. For example, such a system could be targeted to people with a history of falling. Reporting a fall in the previous year is a strong indicator of a future fall (Campbell, A. J., Robertson, R. G., Gardner, M. M., Norton, R. N., Tilyard, M. W., Buchner, D. M., Randomized control trial of a general practice program of home exercise to prevent falls in elderly women, BMJ 315:1065-1069). It can also be targeted to people with significant utilization of medications such as Anti-depressants, digoxin, and diuretics. Leipzig R. M., Cumming R. G., and Tinetti M. E., “in press.” It may also be targeted to people with impairments of gait and balance (Guimaraes, R. M., Isaacs, B. Characteristics of the Gait in Old People who Fall, International Rehabilitative Medicine 2:177-180 (1980)).

Medical treatment for fall-causing disorders is complex and expensive. The goal in managing balance and mobility disorders is to minimize disability and improve functional performance. However, these are difficult to treat because they are complex and usually result from multiple disorders. Patients with similar pathologies frequently present with significant differences in impairments and function. Balance problems can result from combinations of subtle degenerative, infectious, or injury processes, none of which are clinically significant in isolation, but which together raise the risk of serious fall (Tinetti, et al., Dizziness among older adults: A possible geriatric syndrome. Annals of Internal Medicine 132:337-403 (2000)). Because of these differences, patients with similar pathologies respond differently to a given treatment. (Goebel, J. A., ed. Practical Management of the Dizzy Patient, Lippincott, Williams & Wilkins (2001)). Combining the effects of the onset of balance problems that come with age with other age-associated factors, which include decreased bone density and decreased muscle mass, which lead to serious injuries from falls, such as fractured hips, it is unlikely that a “medical” solution is close at hand.

Other approaches include referral to fall prevention programs, and deployment of Risk Reduction Devices (RRD) precautions such as tub grab bars, toilet assist bars, shower chairs, transfer benches, bed assist railings, wall grab bars, rug slips, bath mats, night lights, tread tape, smoke alarms, and carpet tape. Ironically, it has been reported that although walkers and canes have traditionally been thought to prevent falls, these can actually inhibit the ability to recover balance in a near fall. New balance enhancing products have been introduced, such as SoleSensor™ footware, SturdyGrip™ safety pole, and LifeRail™ (Maki, McIlroy, Fernie, Change-in-Support Reactions for Balance Recovery, IEEE Engineering in Medicine and Biology Magazine, March/April 2003)). Additional measures include screening prescription medication for fall risks. A fall protection system such as disclosed here does not interfere with these methods, but instead augments them by providing a last line of defense if there is a fall. Ironically, it has also been reported that people need to occasionally fall to maintain the ability to safely protect themselves in falls (Rietdyk, S., Purdue researcher working to catch elderly before they fall, Purdue News, (Nov. 11, 2003)). Therefore, having an environment such as disclosed here, which is forgiving to falling, could have benefit beyond the environment where it is used.

Pattern recognition is an important component of fall detection. “Pattern recognition,” as used herein, will generally mean any system which processes a signal that is generated by an object (e.g., representative of a pattern of returned or received impulses, waves or other physical property specific to and/or characteristic of and/or representative of that object) or is modified by interacting with an object, in order to determine which one of a set of classes that the object belongs to. Such a system might determine only that the object is or is not a member of one specified class, or it might attempt to assign the object to one of a larger set of specified classes, or find that it is not a member of any of the classes in the set. The signals processed for recognition are generally a series of electrical signals coming from transducers that are sensitive to acoustic, ultrasonic, or electromagnetic radiation (e.g., visible light, infrared radiation, capacitance or electric and/or magnetic fields), although other sources of information are frequently included. Pattern recognition systems may involve the creation of a set of rules. Pattern recognition could also be meant to apply to the size, shape, or motion of objects in an imaging system that might comprise passive video, active laser imaging, active ultrasound, active optical imaging, or radar imaging that permit the pattern to be recognized. These rules can be created by fuzzy logic systems, statistical correlations, or through sensor fusion methodologies, as well as by trained pattern recognition systems such as neural networks, combination neural networks, cellular neural networks, or support vector machines.

A trainable or a trained pattern recognition system as used herein generally means a pattern recognition system which is taught to recognize various patterns constituted within the signals it receives by comparing these patterns to a variety of examples. The most successful such system is the neural network used either singly or as a combination of neural networks. Thus, to generate the pattern recognition algorithm, test data is first obtained which constitutes a plurality of sets of returned waves, or wave patterns, or images, or subsets therein. General models are then generated from the test data, so that once applied to real world data, they can classify the latter data with minimal error.

For the purposes here, the “identity” of a human needs to be understood not only in terms of who that person is, but also to that person's location, or orientation, or mode of locomotion. For example, a human walking normally needs to be differentiated from that same human falling.

To “identify” as used herein will generally mean to determine that the object belongs to a particular set or class. A class may be one containing, for example, persons transitioning from normal walking gait to a pre-fall recovery state, or from an attempted pre-fall recovery to a fall. It may also identify an individual from a group of individuals to apply known patterns of walk and mobility that the system has been trained to identify from that individual to monitor that individual for sudden changes from expected walk or motion that could be the onset of a fall.

An “object” in the field under protection could be another living human or another living organism such as a plant or pet, or an inanimate object such as a box or bag of groceries which might also impede or cause a human to fall.

“Imaging” is taken to mean the measurement of discrete points of the object being imaged in a successive and repeated manner such as to cover that part of the object with a set of measurements which allow for a numerical representation of the object in two or three dimensions, either passively or actively.

In U.S. Pat. Nos. 6,445,988 and 6,757,602, the automatic adjustment of the deployment rate of the airbag based on occupant identification and position and on crash severity has been referred to as “smart airbags.” Central to the development of smart airbags is the occupant identification and position determination systems noted above. Some of the disclosures from U.S. Pat. No. 6,757,602 may be fruitfully applied to a fall protection system with particular regard to the use of ultrasound sensors. Sound velocity is determined by temperature and humidity, so the system in U.S. Pat. No. 6,757,602 was made sufficiently robust to compensate for changing sound velocity conditions. The same considerations are helpful for fall protection, particularly in showers and bathtubs where video imaging methods may be not appropriate or less than optimal.

In U.S. Pat. Nos. 6,445,988 and 6,757,602, “smart airbags” automatically adjust the deployment rate of the airbag based on occupant identification and position and on crash severity. Central to the development of smart airbags is the occupant identification and position determination systems mentioned to above. Some of the features disclosed in these patents are of interest, particularly the use of ultrasound sensors. Sound velocity is determined by temperature and humidity, so the system has be made sufficiently robust to compensate for changing sound velocity conditions. The same will be true in some of the circumstances that will be considered in the present disclosure, for example, in showers when optical methods may be not appropriate or less than optimal.

Detecting human presence and motion is used widely for controlling machines related to safety. Systems have been devised for sensor-based detection of people and for door, escalator, or moving walkway control in automatic door systems (U.S. Pat. Nos. 6,051,829 and 6,323,487) and in approaches to escalators and moving walkways (U.S. Pat. No. 5,923,005).

The prior art also discloses inertial sensors for detecting humans falling. For example, U.S. Pat. No. 5,500,952 utilizes body-mounted inertial sensors to detect a fall and trigger an airbag mounted on the body.

There is also a large body of research regarding application of computer vision to analyzing human movement. Human gait analysis, discussed above, is also important in areas related to human-computer communication, security and biometrics aimed at identifying an individual through his or her motion. Human identification at a distance has recently gained growing interest and funding due to the use of biometrics for homeland security (DARPA Human ID at a Distance, see, e.g., Jessica Jun Lin Wang and Sameer Singh, Video analysis of human dynamics—a survey, Real-Time Imaging, October 2003, vol. 9, no. 5, pp. 321-346). Gait recognition aims essentially to identify people based on the way they walk, and a substantial part of this is done using computer vision. For example, a simple but efficient gait recognition algorithm using spatial-temporal silhouette analysis is illustrated in Wang, Tan and Ning, Hu, Silhouette Analysis-Based Gait Recognition for Human Identification, IEEE Transactions on Pattern Recognition, Vol. 25, No. 12, December 2003. Using video for human motion capture is “the process of capturing the large scale body movements of a subject at some resolution,” which includes applications to surveillance, control and analysis. Wang and Singh (above) cites 154 articles in this area.

Computer vision has been applied to airbag deployment systems in automobiles. Computer imaging is also applied in airbag deployment systems in autos to sense occupant position to determine whether an airbag should be inflated (U.S. Pat. Nos. 5,528,698 and 6,757,602).

Externally-mounted automotive airbag systems are disclosed to detect and protect pedestrians (see, e.g., Diura M. Garivela, Sensor-Based Pedestrian Protection, IEEE Intelligent Systems, Vol. 16, No. 6, November/December 2001 and U.S. 2004/0074688) using such approaches as computer vision and radar.

Laser has been used for detecting anomalous human movements out of doors, (see, e.g., Panacordongadan, A., Matari, M., Sukhatme, G., Detecting Anomalous Human Interactions using Laser Range-finders, IEEE/RSJ International Conference on Intelligent Robots and Systems (IROS) (2004)). Other kinds of sensors have been utilized in automobiles for airbag deployment applications, for detecting human presence and position, and motion after collision has been detected.

Radar, ultrasound, weight (U.S. Pat. Nos. 6,697,723 and 6,757,602 (which also uses optics) and 6,735,508), and optical sensing (U.S. Pat. No. 6,697,723) are also employed in various airbag deployment systems.

It is desirable in light of the above to establish a universal fall protection system with environmentally-based cushions such as, but not limited to airbags, which to not need to be carried around or mounted on individual people and will deploy in response to anyone who may fall.

It is also desirable to establish a system which, in its preferred embodiments, is independent of the person being protected, i.e., in which the sensors are environmental rather than carried by the persons being protected. In alternative embodiments, such system should at least protect from fall, anyone carrying a bodily-carried sensor.

There are numerous literature references recited throughout this disclosure. Below are listed some of the key references, which teach and enable many of the various elements which are utilized—in combination—to realize the system disclosed herein. The teachings of these references establish a base of knowledge for some of the elements which are combined herein into the novel and nonobvious teachings of this disclosure:
Adkin, A, Carpenter, M. G., Frank, J. S., Balance confidence modifies postural control, “in press.”
Boulic, Mas, Thalmann Inverse Kinetics for Center of Mass Position Control and Posture Optimization, “in press.”
Bourke, A., Lyons, G. M., Culhane, K., et al., Fall detection in the elderly using Accelerometry, AAATE 2003 Dublin.
Campbell, A. J., Robertson, R. G., Gardner, M. M., Norton, R. N., Tilyard, M. W., Buchner, D. M., Randomized control trial of a general practice program of home exercise to prevent falls in elderly women, BMJ 315:1065-1069.
Cunado, D., Nixon, M. S., and Carter, J. N., Automatic Extraction and Description of Human Gait Models for Recognition Purposes, Computer Vision and Image Understanding, 90(1):pp. 1-41 (2003)
DARPA Human ID at a Distance, Carnegie-Mellon, http://www.ri.cmu.edu/labs/lab_{—}56.html
DeLisa, J. A, M.D., VA Research & Development, REHABILITATION RESEARCH AND DEVELOPMENT SERVICE, (http://www.vard.org/mono/gait/gaitcov.htm)
Duda, R. O. and Hart, P. E., Pattern Classification and Scene Analysis, John Wiley & Sons, Inc. (Jun. 1, 1973)
Garivela, D. M., Sensor-Based Pedestrian Protection, IEEE Intelligent Systems, Vol. 16, No. 6, November/December 2001, and U.S. 2004/0074688.
Goebel, J. A. ed., Practical Management of the Dizzy Patient, Lippincott, Williams & Wilkins (2001).
Guimaraes, R. M., Isaacs, B., Characteristics of the Gait in Old People who Fall, International Rehabilitative Medicine 2:177-180 (1980).
http://www.intermec.com/eprise/main/Intermec/content/Products/Products_ListFamily?Category=RFID
Inman, V. T. et al., in Human Walking, Rose and Gamble, ed., published by Williams & Wilkins, Baltimore, Md., (1981)
Wang, J. J. L, and Singh, S., Video analysis of human dynamics—a survey, Real-Time Imaging, vol. 9, no. 5, pp. 321-346 (October 2003).
Koski, Luukinen, Laippala, Kivela, Risk Factors for major injurious falls among the home dwelling elderly, Gerontology 44(4) 232-8 (1998).
Leipzig, R. M., Cumming, R. G., and Tinetti, M. E., “in press”
Maki, McIlroy, Fernie, Change-in-Support Reactions for Balance Recovery, IEEE Engineering in Medicine and Biology Magazine (March/April 2003).
Murray, M., Gait as a total pattern of movement, Amer. J. Phys. Med. 46 (1), 290-332 (1967)
Nixon, M. S., Carter, J. N., Shutler, J. and Grant, M., New Advances in Automatic Gait Recognition, Elsevier Information Security Technical Report 7(4):pp. 23-35 (2002).
O'Malley M., Lynn, D. and de Paor A., Kinematic analysis of human walking gait using digital image processing. Medical and Biological Engineering and Computing, 31: 392-398, (1993)
Panacordo A., Matari, M., Sukhatme, G., Detecting Anomalous Human Interactions using Laser Range-finders, IEEE/RSJ International Conference on Intelligent Robots and Systems (IROS) (2004).
Raibert, M. H., Hodgins, J. K., Animation of Dynamic Legged Locomotion, Computer Graphics 25(4) 349-358 (1992).
Robinovitch S. N., McMahon, T. A., and Hayes, W. C., Energy shunting hip padding system improves femoral impact force attenuation in a simulated fall, Journal of Biomechanical Engineering 117:409-413 (1995).
Rabinovich, S. N., Hsiou E. T. et al., Prevention of Falls and Fall Related Fractures through Biomechanics, Exercise and Sport Science Reviews, Vol 8 No 2 (2000).
Sangho, Park, and Aggarwal, J. K., Segmentation and Tracking of Interacting Human Body Parts under Occlusion and Shadowing, IEEE Workshop on Motion and Video Computing, Orlando, Fla., pp. 105-111 (December 2002)
Vellas, B. J., Wayne, S. J., Romero, L. J., Baumgardner, R. N., Garry P. J. Fear of Falling and Restriction of Mobility in Elderly Fallers, Age & Aging 26(3) 189-193 (1997b).
Tinette, M. E., Williams, C. S., Falls, injuries due to falls, and the risk, New England journal of Medicine 337(18) 1279-84 (1997b).
Tinetti, et al., Dizziness among older adults: A possible geriatric syndrome. Annals of Internal Medicine 132:337-403 (2000).
Wagg, D. K. and Nixon, M. S., Automated Model-Based Extraction and Analysis of Gait, Proceedings of 6th International Conference on Automatic Face and Gesture Recognition, Azada, D., Ed., pages pp. 11-16, Seoul, South Korea (2004).
Wang, T., and Ning, H., Silhouette Analysis-Based Gait Recognition for Human Identification, IEEE Transactions on Pattern Recognition, Vol. 25, No. 12, (December 2003).
WHO (2002) 1997-1999 World Health Statistics, World Health Organization 2002

### SUMMARY OF THE INVENTION

Disclosed herein is a fall protection system and related method comprising a sensor; a computerized device receiving detections from the sensor, for deducing fall conditions from the body of a person to be protected, indicating that the person is beginning to fall; and at least one cushion not carried with the person, for deployment at at least one projected impact location where it is projected that impact from the fall will occur, for reducing a force of the impact, in response to detecting fall conditions.

Also disclosed is a flooring system and related method which changes from a hard state to a cushioned state upon receiving a signal to effectuate said change, comprising: a floor surface; a cushioning material beneath said floor surface; a hard floor support for maintaining said floor in said hard state during normal use; and a hard floor support release for releasing said at least part of said hard floor support responsive to receiving said signal, such that once said hard floor support is removed, said floor becomes supported by said cushioning material.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) and appendices summarized below.

FIGS. 1 and 2 are perspective schematic views illustrating a stair fall protection system.

FIG. 3 is a perspective schematic view illustrating a bathroom fall protection system.

FIG. 4 is a perspective schematic view illustrating a shower fall protection system.

FIG. 5 is a perspective schematic view illustrating a bathtub fall protection system.

FIG. 6 is a perspective schematic view illustrating a bed fall protection system.

FIG. 7 illustrates a sensor configuration in accordance with various embodiments of the invention.

FIG. 8 schematically illustrates a computerized device used to model the position and motion of a person to be protected and carry out the necessary analysis to determine if a fall is occurring.

FIG. 9 illustrates a general approach for placement of floor-mounted cushioning responsive to the sensing of FIG. 7 and the computerized analyses of FIG. 8.

FIGS. 10 and 11 illustrate top and side plan views of a particular embodiment of floor mounted cushioning for floor-based fall protection.

FIG. 12 is a side plan view illustrating an airbag-based, fall protection system for an escalator.

FIG. 13 is a side plan view illustrating one embodiment of a pneumatic-style collapsible floor or carpet.

FIG. 14 is a side plan view illustrating a rigid walking surface maintained by pneumatic columns with a screw-to-mounted fabric release.

FIGS. 15 and 16 illustrate perspective hidden and top plan views of a pneumatic-type collapsible floor with a restraining cap and optional foam supports. FIG. 16 employs automobile type “inner tube” donut-shaped pneumatic columns, which is an alternative architecture to reduce cost.

FIGS. 17 and 18 illustrate embodiments of the “cable” in FIGS. 13 and 15. These are the cable stops, which restrain the tile or, in the absence of that, the pneumatic column top. The top is manually or electromechanically-adjustable, controlled by human or machine.

FIG. 19 illustrates a compressed air supply for use in connection with the pneumatic floor embodiments.

FIG. 20 illustrates a side plan view of a spring loaded column for a mechanical-type collapsible floor.

FIGS. 21 and 22 illustrates a top plan view and side plan view of a mechanical-type collapsible floor including a collapsing column with spring loaded lever and electromechanical pin.

FIG. 23 illustrates further aspects of the stairway protection embodiment.

FIG. 24 is a chart illustrating various falls statistics.

FIG. 25 is an illustration of gait analysis, for example, for shin and thigh.

### DETAILED DESCRIPTION

The various embodiments of the invention to be disclosed herein contain two primary interrelated components: 1) a sensor, 2) a computerized device receiving detections from said sensor, for deducing fall conditions from the body of a person to be protected, indicating that said person is beginning to fall, and 3) a cushion which is not carried with the person, but which deploys at an impact location where it is determined an impact from said fall will occur, for reducing said impact, in response to said detecting fall conditions. The link between the sensors and the deployment of cushions, that this, the detecting of fall conditions and deploying appropriate cushions in response, makes use of computer processing and software comprising information classifying body motions into various falling and non-falling categories, and comparing a sensed motion to the classified motions to determine if a fall is taking place. Further embodiments calculate where the point of impact will be, so that the only cushions deployed are those needed to mitigate the fall. In various embodiments, machine learning, neural networks, pattern recognition, and various related techniques commonly though of under the broad rubric of artificial or machine intelligence, also come very much into play in linking what is sensed to what is deployed.

In a number of embodiments, the sensor is not carried on the body of a person to be protected from falls, so that the person can go about his or her daily activities without carrying special equipment. However, such embodiments require sensors to be deployed in the person's environment instead. In other embodiments, a sensor, such as an inertial sensor and/or sensors which determine various flexions of the person's body, is carried on the body. This avoids the need for environmentally-deployed sensors, but does require the user to mount the appropriate sensors on his or her body. Both types of sensors—environmentally-deployed and bodily-carried—can also be used in combination with one another. For example, an inertial sensor worn on the body may sense a quick acceleration, but a video camera, also sensing the person, may detect that the person is sitting into a chair and not falling, so eliminates a false positive.

In some embodiments, bodily-carried inertial sensors trigger an external cushion to soften the fall. In some embodiments, both inertial and environmental sensors, in combination, can help avoid false-positive readings, that is, can detect when a person may be engaged in an activity with a profile similar to falling, such as sitting down or bending over, that might falsely trigger a “positive” fall signal.

In all embodiments, the cushion itself is not attached to the person. While it is reasonable for the person to carry a sensor in some embodiments since this may be very small and light, it is much more intrusive to expect the person to carry the cushions themselves, which could be so cumbersome and inconvenient to use as to cause non-compliance by the person to be protected. Additionally, cushions are generally protective only of a limited body region. To protect all areas of the body, including head, back, elbows, hands, knees, etc., a suitable bodily-mounted cushion would be quite impractical. The objective of the system disclosed herein is to provide complete protection to all areas of the body in a wide range of circumstances, without the need to carry any cushions. The cushions employed include inflatable airbags similar to those used in motor vehicles, as well as the novel and inventive “soft floors,” or “collapsible floors” disclosed herein. As used herein, a “collapsible floor” is a particular type of “soft floor” which is rigid during normal use, and then converts into a soft floor when a fall is detected by removing support underlying the rigid floor such that that support is replaced by soft cushioning. Thus, this floor “collapses” onto the underlying cushioning.

Such an externally-installed cushioning system may be used in homes, residences, or in public buildings, and, again, is a completely passive system not worn on the body. In several embodiments, detection relies on an environmentally-installed set of video cameras and other sensors, and uses various kinds of airbags and soft/collapsible floor. In a home or residence setting, airbags and soft floors are strategically placed in suitable configuration along steps, at the landings of stairways, in showers, on bathroom floors and walls, at the side of beds, and in other places deemed likely to be the locus of a fall. Video cameras or other sensors monitor the areas protected by the airbags and soft floors detect when persons enter, track their motion, and—if a fall is detected—initiate causing an airbag, or group of airbags, as well as soft floors appropriate to the particular situation to catch or cushion the faller(s) and not injure the faller(s) or other persons nearby.

Since the cushions (airbags and soft floors) are notworn on the body, such a system is particularly appropriate for home settings when a worn system is not convenient, e.g., in bedrooms and bathrooms, where one wouldn't be expected to conveniently wear, e.g., a belt-mounted airbag. In fact, for the most part, this system requires no effort on the part of the user. Other kinds of fall safety systems, i.e., railings, require a certain level of strength and cognitive function, and their effectiveness for fall protection thus decreases as a person ages or loses capacity. Such devices are in common use today, yet many serious falls still occur which these devices fail to prevent.

In the home environment, seniors fall primarily in the bathroom, bedroom, and on steps and stairways, for various reasons. Each of these settings has unique features in terms of geometry and potential environmental interference (see, e.g., U.S. Pat. No. 6,649,904). The types of airbags and sensors employed needs to account for the characteristics of each such area.

For instance, fogging and splash potential exists in the bathroom and shower. There are usually cabinets in bathrooms which may be open and may present a hazard to the faller or interfere with airbag inflation. Steps and stairways involve falls from a height with potentially greater forces involved. Falls from the bed or toilet present different sensing signatures than falls while walking, climbing stairs, or standing.

The sensors continuously monitor a user and send the resulting data by hardware or electromagnetic radiation (e.g., radio frequency, infra-red, microwave, etc.) to the associated computerized device. This computerized device recognizes that a fall is in progress as evidenced by acceleration, distance, velocity, direction, stumbling, or a combination of these variables. Upon detection of a fall, the computerized device sends a signal by hardware or electromagnetic radiation to cushioning devices in the path of trajectory of the falling person, using logic for maximizing protection for that person while minimizing hazards to other people in the area. For instance, if two elderly people are standing close to each other and one begins to fall, the system may use logic to deploy cushioning devices only for the falling person, without compromising the stability of the non-falling person. Or, the controller may sense that both will fall and pro-actively deploy cushions for both of them.

In the situations where the system is protecting a large public area, such as an elevator in a shopping mall or customer reception area for a doctor's office, the computerized device will use standard pattern recognition methods based on large mixed population. For instance, in one embodiment, normal versus abnormal gait classes for young people and elderly is included.

The biomechanics of falling from a standing height requires that the system react to deploy within 0.5 seconds or less. For example, in a vertical fall from standing, for a 5 foot person, the hips drop 2.5 feet due to gravity and will land on the ground in 0.39 seconds. The system needs to detect the fall and deploy cushioning in this time or less.

The computerized device underlying the sensor system calculates the direction, speed and force of fall, and inflates only airbags appropriate to the situation to cushion or stop the fall without inflating airbags that may cause the person to fall or other persons to fall.

Where mixed groups live in the same house, say grandparents and grandchildren, it is also useful to differentiate them, for example, by the use of (e.g., radio, infrared) proximity ID devices to initiate action. That is, each person to be protected carries a radio frequency identification tag (RFID) (see http://www.intermec.com/eprise/main/Intermec/content/Products/Products_ListFamily?Category=RFID) which signals to the system who that person is. This is because the system will need to respond differently, for example, to a sudden motion by a child at play than to the sudden motion of an elderly person truly starting to fall. Similarly, what is required to respond to a 50-pound child, or, e.g., a dog or cat, will be different than what will be required to respond to a full-sized adult. Further, when remote identifying devices are employed, a default is to do nothing unless the person is carrying such a remote identifying device, that is, to only respond to persons carrying the remote identifying device.

It will be preferred in this disclosure, though not required, to employ a completely video based system, when possible, for fall detection with minimal errors. This is because video imaging for human motion sensing overlaps with many other fields, and motion sensing is an area of rapid evolution. In addition to using the kinetic modeling approach noted in the background of the invention discussion, it will be important to achieve a lower level of false negatives, particularly because the disclosed system does alter the environment in the sense of deploying airbags or removing the underlying support from soft floors. And it is at the very minimum inconvenient to refold or replace the airbags or to redeploy the soft floors, while in the worst case these measures could be dangerous if they are needlessly employed.

A preferred detection system is based on a network of video, active laser imaging, active ultrasound, active optical imaging, or radar which image the scene being protected, and detect and track a person with one or a fusion of multiple cameras and multiple sensors. The data is obtained as or converted to digital format, which is then input into the computerized device which uses a set of rules to determine if a person is in a fall state or is exhibiting aberrant motion.

Prior to the detection of characteristic accelerations of falls, certain other measurements can be used as “training” to “alter the threshold” of detection. This includes gait ID signature change, and change in support reactions. Neural nets provide another approach to “learn” what a “fall” is.

In a preferred embodiment, test subjects, in clinically approved facilities, are employed for training the pattern recognition component of the system disclosed herein, to recognize the onset of a fall in a person being protected. Normally, test subjects should be younger people, 19-36, who are monitored as they fall onto mats. (Rabinovich, S. N., Hsiou E. T., Prevention of Falls and Fall Related Fractures through Biomechanics, Exercise and Sport Science Reviews, Vol 8, No 2 (2000)). Older people behave somewhat differently in falls, and therefore models of differences between falls for young and old will needed. For instance, younger people are known to use fall protective responses, such as use of hands, to protect the body from a forward fall. Young people, for instance, therefore have a high occurrence of wrist fractures, yet very few hip fractures (Rabinovich, S. N., Hiou, E. T. et al., Prevention of Falls and Fall Related Fractures through Biomechanics, Exercise and Sport Science Reviews, Vol 8 No 2, (2000)). This changes with age, as hip fractures are proportionally much higher in the elderly.

Thus, to generate a trained pattern recognition algorithm, test data is first obtained, from humans in a room, on a deck, in a shower, on a step, stairwell, or escalator, etc. The characteristics of those humans, e.g., age, gender, height, weight, etc. are also considered. A number of different humans are tested to obtain the unique data patterns from each human. A general model is then be generated from test data (“crash tests”) to build large general classes for normal motion as opposed to falling. For deployment to a general or transient population, this data may be used “as is,” with no further refinements. However, in the case of a home or institution, the system can then learn more about each protected individual on top of the baseline of general population data. The collection of additional data builds a more complex and accurate biomechanical model, or retrains the network to distinguish normal versus abnormal movement based on observations of that individual. As such, the algorithm is generated and stored in a computer processor. It is then applied to provide the identity of the humans in the protection zone or states of motion of those humans (i.e. normal walk, stumble, attempted recovery, fall) based on the motion patterns being sensed. For the purposes here, the “identity” of a human needs to be understood not only in some cases in terms of who that person is, and that person's location, orientation, and gait or movement. For example, a person walking normally needs to be differentiated from that same person falling, where the method of discrimination may be based on a group-based model or an individual-based model, or a combination of both.

In certain situations, other types of sensors, such as infrared, optical, laser, radar, or sound may be utilized instead of video, either to enhance or replace video in places like the bathroom and shower, where imaging with a camera, although in most cases only closed circuit except in emergency situation, could be considered an invasion of privacy. As noted, cameras in the shower or bathroom are also subject to fogging and other environmental problems and so may not be optimal. Some seniors may be confused or not understand what “closed-circuit” means, but it has been shown that seniors will give up some of their privacy concerns in exchange for increased feeling of well-being (Activity summarization, above), and the introduction of monitoring technology into the home also has to be considered against the consequent loss of privacy that would occur should the senior enter a hospital or nursing home.

Depending on the particular situation, it will be desirable to deploy different types of cushions, separately, and in various combinations.

For example, the curtain-type airbags employed in this disclosure are similar to what is currently utilized in the auto industry for side-impact crashes. Curtain airbags in many cases are deployed at approximately floor level (or step level) along the wall (or step) and inflate outward horizontally to cover a floor or stairway space. In some situations, it is also desirable to employ a floor mounted airbag that inflates vertically. A side-mounted system has certain advantages. It isn't stepped upon and therefore less liable to wear. Also, it is perhaps more suitable under cabinets and closet doors which would block a floor mounted system. In some environments like the bathroom, arrays of curtain-type airbags may be utilized to optimally adapt the response to the fall without causing injury or further imbalance to the faller.

A floor-mounted airbag may be useful in places where no appropriate side wall or panel exists for mounting a side system, i.e. at the bottom of steps, escalators, shower or bathtub. Additionally, the airbag should be constructed so that after deployment it can be easily refolded and replaced, or the apparatus re-loaded with a new airbag after use. In many situation, soft floors may be equally or even more appropriate than airbags.

As will be discussed, larger, balloon-type airbags are particularly useful to slow the fall in a stairway environment.

It is also desirable to account for differences in size and weight of the person being protected, and so the system disclosed herein employs several kinds of adaptive airbags which may be used for this purpose.

One of the challenges presented in developing a fall protection system involves the mounting of airbags on a floor. In automotive airbag systems, airbags deploy from a dashboard, or a steering column, or from above a window, but not from underneath where a person is sitting. For fall protection, there will often be situations in which the only practical place from which an airbag can deploy is beneath a floor. However, since floors are of course for walking and standing upon, an incorrect airbag deployment can itself create a serious safety hazard. Certainly, for example, it is easy to imagine that if a person is falling, it would be a terrible idea to deploy an airbag under that person's feet. Such deployment would only make matters worse. On the other hand, it is desirable to inflate airbags (or more generally, to create a cushioned restraint) in the locations of the floor where impact is likely to take place, but not under the person's feet.

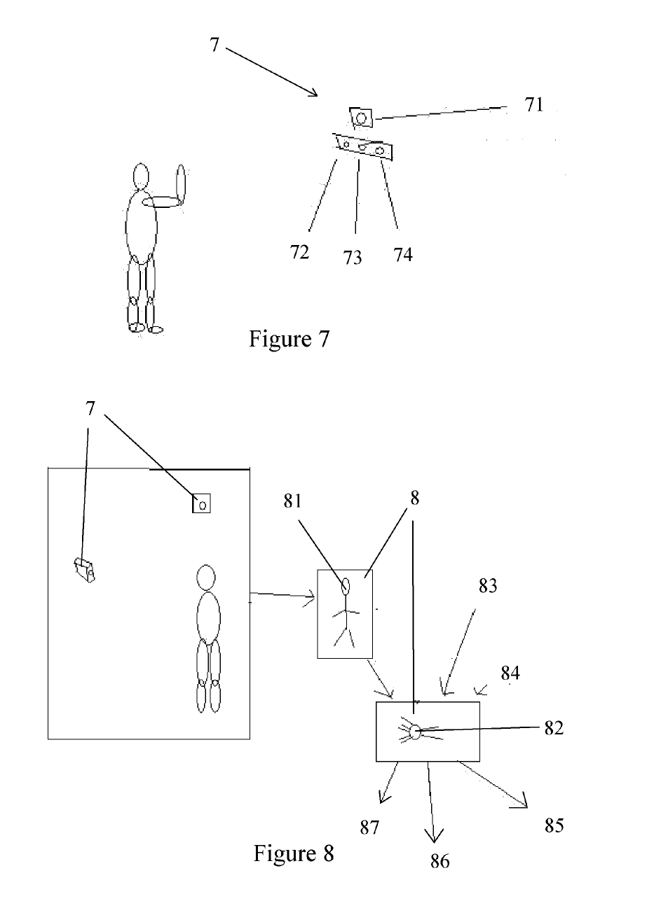

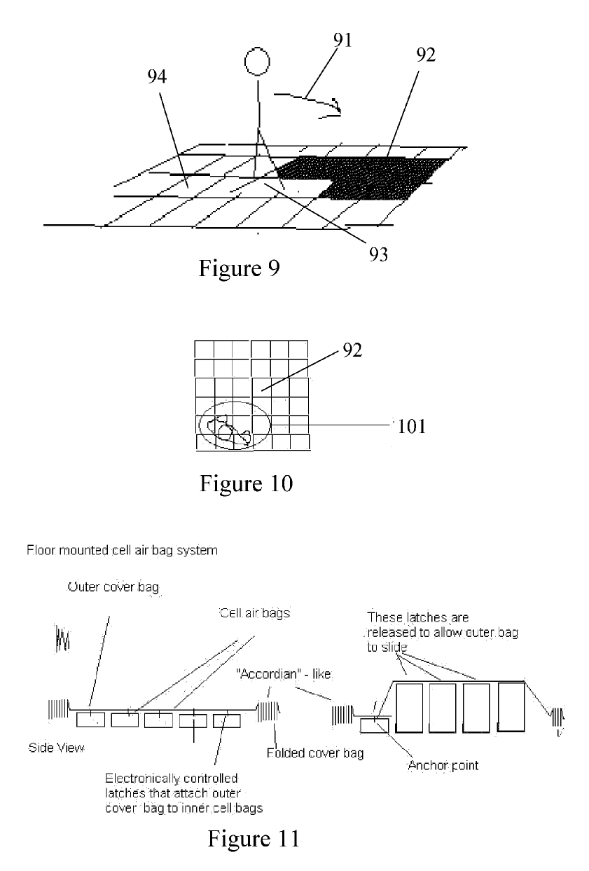

Thus, FIG. 9 illustrates some of the general considerations which apply to floor-deployed airbags. When a fall condition is detected for a person on a floor surface, it is necessary to predict an impact location. In addition, it is important to determine where that person is actually standing, which can be improved through weight sensors, and/or the various sensory systems illustrated in FIGS. 7 and 8. The floor cushions, in a preferred embodiment, comprise a plurality of individually-deployable airbags or soft floor panels, arrayed in a grid-like configuration, as illustrated. For simplicity, a rectangular grid is illustrated, but it is understood that other geometries may also be suitable in a given circumstance within the scope of this disclosure, and so the particular illustrated grid geometry is not limiting but exemplary. The direction of fall 91 and a likely impact location is determined. Cushions within the grid in the projected impact area 92 are deployed; whereas cushions under the person's feet at 93 as well as cushions in the non-projected impact area 94 are not deployed.

This, again, is to ensure that the system not be the cause of the user falling or become unbalanced by deploying cushion, airbags, etc. from the side at their feet or under their feet.

In the case of a person standing on a level floor, ⅔ of a person's weight is distributed on the upper ⅔ of the body, so the body is similar to an inverted pendulum (Codero, F., Human gait, stumble and . . . fall, Thesis University of Twente, Netherlands, ISBN 90-365-1912-8 (2003)).

In one embodiment, using a computer vision “model-based” system (e.g., Wagg et al.) to locate the center of mass using the biomechanical model, one could calculate likely limits of the region of a falling human based on mechanical constraints on joint angle and height and other factors (Boulic, Mas, Thalmann, Inverse Kinetics for Center of Mass Position Control and Posture Optimization, “in press”, and Raibert, M. H., Hodgins J. K., Animation of Dynamic Legged Locomotion, Computer Graphics 25(4) 349-358 (1992)), and deploy those cushioning surfaces selectively or in a grid or circular or similar pattern around the person.

In particular, fall detection in accordance with this disclosure may be based, for example, on published research in the area of human gait identification (Wagg and Nixon). In this approach, a kinesthetic model of the human body walking is calibrated using a computer vision system that extracts body segments (i.e. thigh, arms, calf, etc.), called evidence gathering, and their size and relative angles of motion. The technique is demonstrated to be robust to noise and occlusion.

The ability to track and segment individual body parts is also highly evolved and can be achieved robustly, even with occlusion and shadows, as well as the presence of more than one individual in the scene. (Sangho, Park, and Aggarwal, J. K., Segmentation and Tracking of Interacting Human Body Parts under Occlusion and Shadowing, IEEE Workshop on Motion and Video Computing, Orlando, Fla., pp. 105-111 (December 2002)).

From either sensors worn on the body, or using the segmented body parts from computer vision, the disclosed system calculates velocity, distance, and angular velocities of individual body parts. A large number of different values to these measurements could result in a fall. For instance: 1) no supporting body part on the floor for a certain length of time; 2) a rapid rotation of the torso and legs simultaneously; 3) high vertical accelerations of the torso; or 4) high vertical and horizontal accelerations of the torso can all be indicators of impending fall. One may also use here, a MEMS angular rate sensor.

Based on this, it is possible to enter into more sophisticated gait analysis that could potentially make the system more robust, to detect pre-fall conditions that might allow for greater accuracy or also for the system to provide other protective measures, such as indicate to care providers the onset of fall-prone behavior.

Much prior gait analysis has been done using invasive techniques, e.g. attaching a goniometer and accelerometer, using a multiple exposure camera techniques (Murray, M., Gait as a total pattern of movement, Amer. J. Phys. Med. 46 (1), 290-332 (1967)) with reflective markers (O'Malley M., Lynn, D. and de Paor A., Kinematic analysis of human walking gait using digital image processing. Medical and Biological Engineering and Computing, 31: 392-398, (1993)) on the subject's body. These methods can all be applied individually or in conjunction with each other for purposes of this disclosure. An area of published research in human gait recognition, so-called “model-based” recognition, involves utilizing a biomechanical model of the human musculoskeletal system and provides constraints of only allowable motions of the body for body motion extraction, thereby reducing noise effects (Wagg and Nixon). In some sense the model-based computer vision system is easier for home-based systems, or for residences with limited populations, than for large populations, because the small population of the home or residence population allows more time for optimizing biomechanical models for each protected individual. Gait recognition, in contrast, entails learning about large numbers of random individuals on the fly. Another benefit of the “model-based” approach for the system disclosed here is that while gait recognition is primarily oriented toward the legs and lower torso, a “model-based” system can be extended to be increasingly-complex (Wagg et al.), presumably to include upper torso and arms. Change-in-support reactions, associated with balance recovery attempts (Maki) have been shown to include arm and upper torso motions (reaching). Increasing the complexity of the published “model-based” approach to include arms and upper torso would presumably extend its usefulness in fall detection.

Animation is another area where sophisticated kinesthetic models are being researched. Increasingly-lifelike animated models being developed can also be applied, providing increasingly-sophisticated biomechanical human models to, for instance, calculate forces, joint angles, and motions of a falling person. (Raibert, M. H., Hodgins, J. K., Animation of Dynamic Legged Locomotion, Computer Graphics 25(4) 349-358 (1992)) For reasons discussed below, this is important in detecting if a person is falling, how they are falling, and where they are likely to land so that appropriately-located protection can be deployed.

The Wagg and Nixon research discloses automated non-contact and markerless analysis systems using computer vision techniques. A structural motion model derived from forced coupled oscillators, which can describe the spatio-temporal characteristics of human running and walking gaits, serves as the basis of an evidence-gathering technique used to extract leg motion. The system can be extended with increased dimensions to include torso, arm, and head motion as well for increased precision and flexibility for other activities, such as body motions while standing, thrusting, or sitting to account for onset of fall from these other positions. The research using camera data from lower leg motion, and harmonic analysis, could be trained on an individual and identify the individual. Importantly, this non-contact, markerless and automated feature extraction process was also shown to be invariant to gait mode (walking or running, and speed).

Unintentional falling is an aberration of walking. Therefore, using a system that can capture and adequately classify individuals based on gait (body motion), it is reasonable to conclude that individual gait signature during the onset of an unintentional fall will be associated with an identifiable shift from a normal walking gait signature for that individual. Therefore, using the technique demonstrated in Wagg and Nixon, one can build a robust computer vision-only fall detection system that can be applied to all individuals without use of additional kinds of sensors.

It is also appropriate to consider that not all falls occur when the individual is walking or running with a well established gait, but also occur when the individual is standing or sitting, or thrusting (moving a short distance, i.e., into the shower), and may also involve sitting motions (into a chair or bath tub). However, a system which can classify an individual as in a stable or unstable standing position or thrusting motion based on body segmentation and respective angles and motions (i.e., there is an identifiable signature for stable standing and thrusting that can be obtained by training the system for a particular individual), could also recognize a signature shift when the person changes from a standing position to an onset of fall characteristics. Similarly, such a system can work for a person sitting, or moving from the bed to standing on the floor. In the case of a bed, considerable research has been done sensing body position in bed with pressure sensors. While often employed for medical purposes, these could augment the computer vision system that may be inhibited by blankets and bed covers. (DVA Palo Alto Health Care System SleepSmart, http://guide.stanford.edu/Projects/98projects/smartbed.pdf). Protection near bed is particularly important, because a high percentage of falls in the elderly are due to rushing from bed to the bathroom due to incontinence problems.

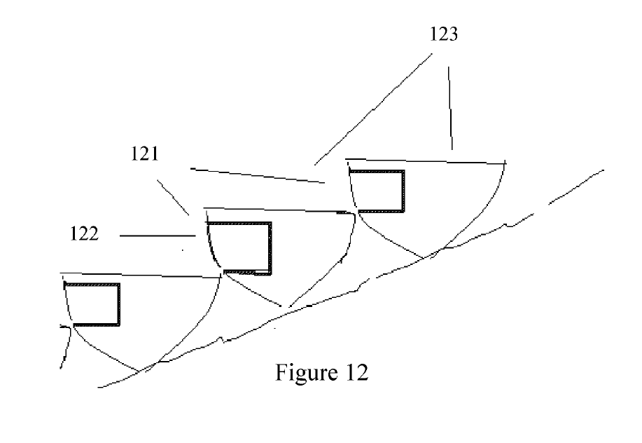

FIGS. 10 and 11 illustrate a more detailed embodiment for a floor-mounted cushion grid, employing a cellular airbag array. This can also be employed in connection with the collapsible soft floors later disclosed. FIG. 10, which is a top plan view, illustrates how airbags located near a person's body do not deploy, but those in the projected impact area 92 do deploy.

Published research (Bourke, A., Lyons, G. M., Culhane, K., et al., Fall detection in the elderly using Accelerometry, AAATE 2003 Dublin) has also been done using accelerometers mounted on the trunk and thigh. Using this method, it was possible to detect four different types of falls, namely forward falls, forward two-stage falls, backward falls and backward two-stage falls, using measurements of the acceleration of several points of the body and applying thresholding. It is this approach, when combined with computer vision technique of Wagg and Nixon which essentially segment the body in a video image into constituent parts to identify gait, that could also measure the acceleration of these body parts in a way that would enhance or replace the accelerometer.

FIG. 11, from a side view, illustrates a floor mounted airbag system for showers. This is an embodiment of a floor mounted airbag system such as might be used in wet environments where no large objects or furniture are likely to be placed on the floor, such as in a shower. Here, a fabric covering the entire floor that provides a no-slip footing for the user and provides a protective cover over floor mounted airbags arrayed, for example, in a matrix as in FIG. 4. The cover, in one embodiment, has pins on the bottom that are secured to the lower layer with electromechanical latches that release when the airbags are deployed. The purpose of this is to provide a means of securing the covering to the lower layer and floor, and force the covering to not slip beneath the user's feet. Also, in one embodiment, the covering is folded on the sides to allow the covering surface area to expand to conform to the shape of the deployed airbags.

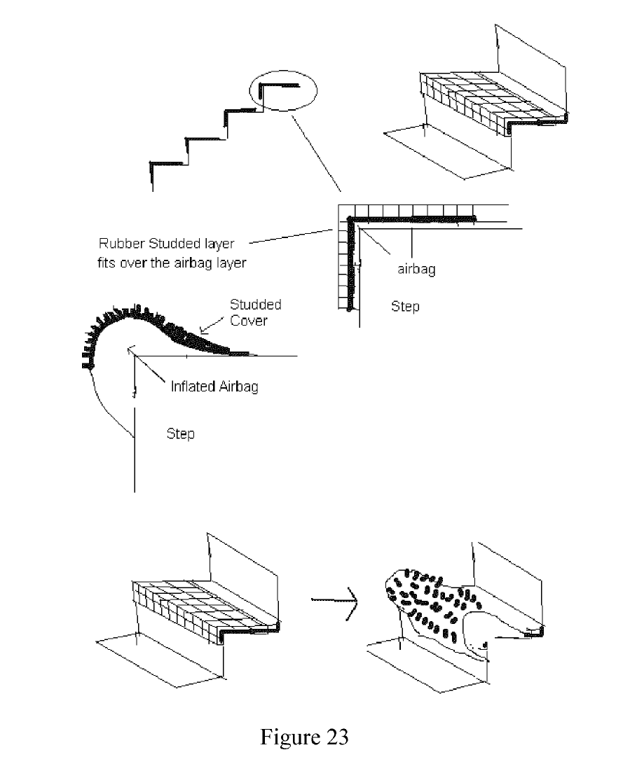

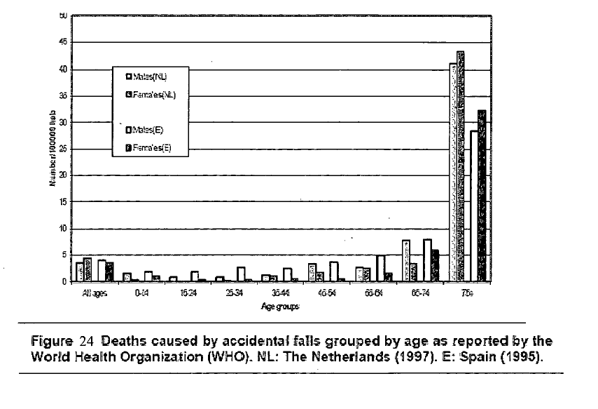

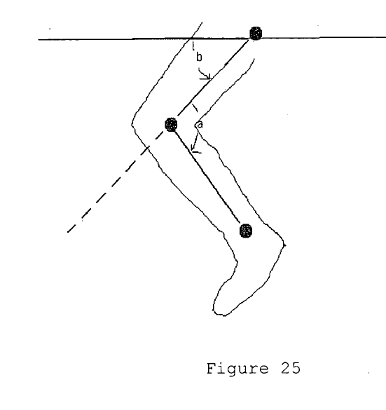

In a stair-mounted airbag embodiment of FIG. 23, a rubberized fabric of, for example, 1″ thickness is incised in a rectangular fashion with rows of cuts to about ¾″ from the top, such that the effect is to create squares about 1″×1″. The fabric is rigid enough to provide a safe walking surface, similar to the rubber of a car tire. A covering made in this fashion is mounted over airbags which are mounted on the floor of each step. One edge of this covering hangs vertically over the top of the step riser, and is secured to the rising of the step. When the airbag is deployed from below, this conforms the airbag into a convex shape. Because it is deformed from a flat surface to a convex surface, the surface exposes these rubber posts for providing friction to slow the momentum of the faller, as illustrated.

As has already been discussed, an important part of the system disclosed here involves the ability to detect the motion of the person to be protected, determine that a fall is taking place, and determine the likely point of impact which will in turn establish where to deploy—and not deploy—airbags.

U.S. Pat. No. 6,736,231 discloses a number of embodiments which serve a similar function in an automobile. However, in an automobile, the occupants are confined to a limited space and the range of motions are relatively well-defined, while in, say, a stairway, the calculations required to determine that a fall is taking place and calculate trajectory based on what is detected by the detectors are more complicated.

FIG. 7 illustrates the detectors, generally denoted as 7, employed to detect a fall, in one embodiment of the invention. In this embodiment, imaging from a camera 71 is combined with readings picked up by ultrasonic transducers 72, 73, 74. While three transducers are illustrated, any number of wave-transmitting transducers or radiation-receiving receivers (e.g., radar) may be used. Such transducers or receivers may be of the type which emit or receive a continuous signal, a time-varying signal or a spatially-varying signal such as in a scanning system. One particular type of radiation-receiving receiver for use in the invention is a receiver capable of receiving electromagnetic waves. In an embodiment wherein ultrasonic energy is used, center transducer 73 transmits ultrasonic directed energy toward the person to be protected. This radiation is received, after reflecting off the person, by the transducers 72 and 74. The waves received by transducers 72 and 74 vary with time depending on the shape and motion state of the person to be protected. The pattern of waves received by transducer 72 will differ slightly from the pattern received by transducer 74 in view of its different mounting location. In some systems, this difference permits information to be derived through triangulation. Through the use of two transducers 72, 74, a stereographic image is received by the two transducers and recorded for analysis by a computer processor which is connected with transducers 72, 73, 74. Elements 72, 73, 74, although described as transducers, are representative of any type of component used in a wave-based analysis technique, including, e.g., a transmitter and a capacitor plate. The ultrasound, or radar, or, e.g., laser is scanned across the body creating “slices” which are then reconstructed into whole body images, by the computer processor, in fractions of a second.

The image recorded from each ultrasonic transducer/receiver, for ultrasonic systems, is actually a time series of digitized data of the amplitude of the received signal versus time. Since there are two receivers, two time series are obtained which are processed by the computer processor. The processor may include electronic circuitry and associated software. A computer processor constitutes one form of generating information about the subject being sensed based on the waves received by the transducers 72, 73, 74.

It is also helpful to identify what is in front of the sensor system, that is, to determine that the object belongs to a particular set or class. The class may be one containing humans in a certain height or weight range depending on the purpose of the system. In the case of walking patterns that may result in a fall (unusual sway, unusual clumsiness, etc.) where a particular person is to be recognized, the set or class will contain only a single element, the person to be recognized. Some examples follow:

In a passive infrared system a detector receives infrared radiation from an object in its field of view, in this instance person to be protected, and determines the temperature of that person based on the infrared radiation. The system can then respond to the detected temperatures. This technology provides input data for pattern recognition, but it has limitations related to temperature. The sensing of the human needs to account for whether the human is covered with clothes or in the shower. It may also be problematic to detect the human if the ambient temperature reaches body temperature as it does in hot climates. Thus, temperature-based detection is useful to consider it in certain cases, for instance imaging when there is no ambient light or low light, at night and during sleep, or as additional sensory input, to recognize a warm human body against a cooler background.

In a laser optical system an infrared laser beam is used to momentarily illuminate the person to be protected, as, for example, is illustrated in FIG. 8 of U.S. Pat. No. 5,653,462. In some cases, a charge-coupled device (CCD array) or a CMOS device is used to receive the reflected light. The laser can either be used in a scanning mode, or, through the use of a lens, a cone of light can be created which covers a large portion of the person. Also triangulation can be used in conjunction with an offset scanning laser to determine the range of the illuminated spot from the light detector. In each case, a pattern recognition system, as defined above, is used to identify and classify, and can be used to locate, the illuminated object (e.g., person) and its constituent parts. This system provides a great deal of information about the object and at a rapid data rate. Its main drawback is cost, which is considerably above that of ultrasonic or passive infrared systems. Depending on the implementation of the system, there may be some concern for the safety of the subject if the laser light can enter the subject's eyes. This is minimized if the laser operates in the infrared spectrum.

Radar systems have similar properties to the laser system discussed above. The wavelength of a particular radar system can limit the ability of the pattern recognition system to detect object features smaller than a certain size. However, there is some concern about the health effects of radar on children and other humans. This concern is expressed in various reports available from the United States Food and Drug Administration Division of Devices. Naturally, electromagnetic waves from other parts of the electromagnetic spectrum could also be used such as, for example, those used with what are sometimes referred to as capacitive sensors, e.g., as described in U.S. Pat. Nos. 5,366,241; 5,602,734; 5,691,693; 5,802,479; 5,844,486; 5,948,031, and 6,014,602.

An ultrasonic system is the least expensive, but it potentially provides less information than the optical or radar systems due to the delays resulting from the speed of sound and due to wavelengths which are considerably longer than the optical (including infrared) systems. The wavelength limits the detail which can be seen by the system (limited resolution). Despite these limitations, as shown below, ultrasonics can provide sufficiently-timely information to permit the position and velocity of a human to be accurately known, and, when used with an appropriate pattern recognition system, it is capable of determining if a person is accelerating in such a fashion as to indicate a fall. One pattern recognition system which has been used with regard to airbag deployment in cars, particularly to identify a rear-facing child seat in automotive applications using neural networks, is similar to that described in Gorman et al.

A focusing system, such as used on some camera systems, could be used to determine the position of an human but may be too slow to monitor position during a fall. This is a result of the mechanical motions required to operate the lens focusing system. By itself, a mechanical focusing system cannot determine the onset of fall behavior but when used with a charge-coupled device plus some infrared illumination for night vision, and an appropriate pattern recognition system, this does become possible.

From the above discussion, it can be seen that the addition of sophisticated pattern recognition capability to any of the standard illumination and/or reception technologies such as those used in a motor vehicle permits the development of a host of new products, systems or capabilities described herein which are heretofore not available.

Another type of sensor which may be used in connection with this disclosure, which is not believed to have been used in existing automotive interior monitoring systems, is a micropower impulse radar (MIR) sensor which determines motion of a human and thus can determine his or her heartbeat (as evidenced by motion of the chest). Such an MIR sensor could be arranged to detect motion in a particular area in which the human's torso would most likely be. This may be situated from images of the person, or could be coupled to some other sensory arrangement which determines the location of the occupant's chest and then adjusts the operational field of the MIR sensor based on the determined location of the person's torso. A motion sensor utilizing a micro-power impulse radar (MIR) system is disclosed, for example, in U.S. Pat. No. 5,361,070, as well as many other patents by the same inventor. Motion sensing is accomplished by monitoring a particular range from the sensor. MIR is one form of radar which has applicability to human motion sensing and can be mounted at various locations in the room. It has an advantage over ultrasonic sensors in that data can be acquired at a higher speed and thus the motion of a human can be more easily tracked. MIR has additional advantages in lack of sensitivity to temperature variation and has a comparable resolution to about 40 kHz ultrasound. Resolution comparable to a higher frequency is feasible but has not been demonstrated. Additionally, multiple MIR sensors can be used when high speed tracking of the motion of a human during a fall is required, since they can be individually pulsed without interfering with each through time division multiplexing.

Finally, while the various sensor systems discussed above may potentially be employed within the scope of this disclosure and its associated claims, it is possible to do the necessary motion sensing solely with cameras. Indeed, the current state of the art for full body motion capture for the video game and animation industry does rely solely on cameras, and the teachings in those art areas are applicable here as well.

Specifically, complete video camera/computer-based motion capture and analysis systems are available commercially off the shelf and are used widely in animation, video gaming, gait analysis, biomechanics and orthopedics. These systems capture in real-time, a three dimensional model of human motion. See, for example, one vendor's integration of gait analysis application (www.motionanalysis.com) is said to “offer state-of-the-art, high resolution, accurate motion capture systems to acquire, analyze and display three dimensional motion data on patients while walking. The system is integrated with an analog data acquisition system to enable simultaneous acquisition of force plate and electromyographic data.”

Such a system, when used in conjunction with a pattern recognition algorithm, could be trained through machine learning techniques to detect the onset of a fall, for instance by using a training set of training subjects in laboratory conditions to provide data to the system about the signature of a 3-dimensional human model about to fall. (This may be envisioned as “crash tests” for fall protection.) There is a challenge presented here because test subjects will probably need to be limited to young and healthy subjects and extrapolated to older people. Or, safer ways to use older people as test subjects would need to be considered, such as with slings or harnesses. Additional data, such as medical monitoring, could provide data about health state, such as a variation in blood pressure which indicates proximity of a fall risk. If detected in time, this could provide the user with advisement to sit down rather than risk a fall.

A computer vision method and apparatus for sensors for recognizing and tracking occupants in fixed environments under variable illumination is disclosed in U.S. Pat. No. 6,608,910, which describes using a computer vision system for tracking people in a car or room, and which illustrates the nature of an a system adaptable to fall protection that utilizes computer vision to assess the state and safety of humans before deploying a potentially harmful cushioning device.

FIG. 8 schematically illustrates the various considerations involved in video, 3-dimensional motion capture. Sensors 7, as discussed above, are used to sense position and motion, and this information is fed into a computerized device 8 which contains a model/representation 81 of the person's body. This information feeds to a neural network (or other appropriate machine learning/artificial intelligence system) 82 along with other items of information, for example, metabolic data (e.g., blood pressure, pulse) 83, pressure data (such as from floor monitors which detect the weight of the person as well as weight shifts) 84. The output from computerized device 8, is a classification of the data into normal/do nothing 85, possible fall 86, or definite fall 87.

Having set out the general considerations underlying the system, devices and methods disclosed herein, we now turn to examine this system in several specific embodiments: for stairways, for bathrooms, and for bedrooms. The enumeration of these three specific embodiments in no way precludes the application of the disclosures herein to other embodiments, and other such embodiments are regarded to be within the scope of this disclosure and its associated claims.

Steps and stairs present a particularly-challenging problem. It is important to both cushion the fall, and attempt to slow the rate of descent for people falling from the middle or top of the stairs. Although falls on stairs primarily happen when people are descending them, it is desirable to account for all cases. A worst possible case is a fall backwards from the top of the stairs in which one would lose the use of hands and arms for head and neck protection during the inevitable slide downward. According to the National Safety Council nearly one million people suffered an injury due to falls on steps or stairs in 1994.

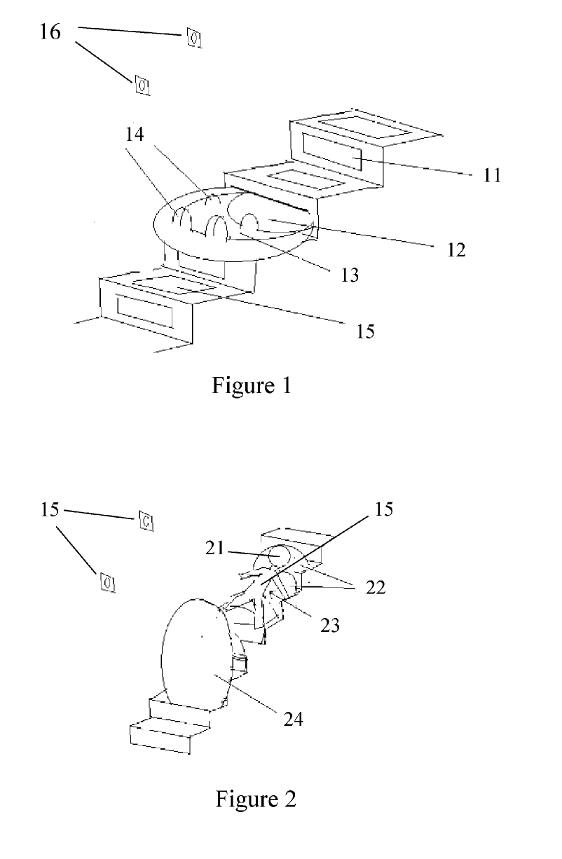

FIG. 1 illustrates a riser-mounted airbag system in one embodiment of the invention. Airbags are mounted behind the risers 11 of the stairs, similarly to how an automotive airbag is mounted, for example, behind the dashboard or steering wheel of an automobile. The risers comprise a material (for example, not limitation, polymers) such as those commonly employed in, e.g., automotive dashboards, which the airbag can break through when it needs to be deployed. Airbags can be behind each riser, or behind a subset of the risers (for example, not limitation, every other riser, every third riser, every fourth riser, more airbags toward the bottom of the stairs versus the top, etc.).

When a sensor 16 detects fall conditions from the body of a person to be protected, indicating that this person is beginning to fall, the system projects where the impacts are likely to occur, determines which airbags to deploy, and deploys those airbags in response to detecting these fall conditions. The illustrated inflated unit 12 has broken through the riser on its step, as shown. Inflated unit 12 preferably contains an adhesive coating 13, for example, “dimple” formations on the airbag, and flypaper-like adhesive may be used for increased frictional forces. Adhesion may be chemically enhanced. This adhesive coating 13 causes the airbag to cling to the faller to slow or stop the fall down the stairway. The role of the adhesive stairway curtain airbag and single step airbags is to cushion the fall with its elastic properties and to slow or stop the fall with its adhesive properties.

An example of a suitable “gummy” adhesive is that which is used commonly in non-lethal mouse traps for immobilizing rodents. Trappers glue board by Bell Laboratories, Inc., or 3M™ Gummy Glue Removable Adhesive, are two examples of suitable adhesives for this purpose. A person who is falling will of course end up thereafter with such a glue all over themselves, and will likely ruin their clothing and need to use suitable solvents to remove the glue from their body; yet that is far preferable to a fatal or disabling fall.

Also illustrated are horizontally-oriented tearable materials 15 on the horizontal step surface. Under-step airbags illustrated in FIG. 2 break through these tearable materials 15 when they are deployed. So, for example, as shown in FIG. 2, when a person 21 has begun to fall, single-step airbags 22 inflate from under the horizontal step surface through the horizontally-oriented tearable materials 15 to cushion the immediate fall at the immediate projected impact locations. Of course, person 21 will continue a deadly slide down the stairs if something is not done to restrain the downward motion in addition to providing immediate cushioning. Thus, single-step airbags 22 preferably also comprise an adhesive coating 23.

Lower on the stairway, a larger, balloon-type airbag 24 is also inflated. This airbag is larger than the upper airbags, so as to fully obstruct and cushion the fall further down the staircase. It is also desirable to provide an under-floor airbag (not shown) emerging from the horizontal flooring surface at the landing (base) of the entire staircase.

In a preferred embodiment, a balloon airbag is used to stop or slow the fall on a staircase. This balloon airbag is sufficiently large to block descent down the stairway entirely, as illustrated in FIG. 2. Obviously the physics of cushioning or stopping a fall to the floor is different from stopping a fall midway down the stairs or escalator. The person is falling from a height, and physics dictate that the larger the vertical distance of a stair fall (i.e. stair versus floor height), the person will be moving at the end of a fall from a stair at a velocity which varies with the square root of the height from which the fall began. Because energy varies with the square of velocity, the energy of impact will thus vary in proportion to height, with potentially-deadly consequences for a fall originating high upon the stairs. Also on, say, a mid-point on the stairs, there is no natural plane to cause force opposite to faller, as there is on the flat floor falls. This is why, in a preferred embodiment, the stair fall system disclosed herein employs airbags with frictional properties in addition to their cushioning properties. Thus, for example, a balloon bag blocks the faller's path and creates a force normal to the faller to stop the fall as gently as possible. A balloon airbag cushion is also positioned and deployed at the bottom of the stairs.

FIGS. 1 and 2 are not mutually-exclusive. That is, various combinations of riser-(vertically-)mounted and step-(horizontally-)mounted airbags can be use to improve the protection of the overall system, and different types of airbags (including air “curtains” which are thinner airbags) can be mounted in different locations to effect different ends. For example, not limitation, it is to be noted that an airbag such as 12 emanating from a vertical (riser) section of the stairway provides cushioning against impact with the with horizontal stair, but may be less suited to slow downward momentum than an airbag such as 24 in FIG. 2 emanating from a horizontal (step) section of the stairway. The overall objective is to combine cushions, e.g., airbags, in such a way as to both cushion the fall and slow or stop the downward momentum of the person falling. It is understood that a person of ordinary skill will be able, based on this disclosure, to envision a wide range of airbag locations and airbag-type combinations suited to the overall objective of moderating a stairway fall, all within the scope of this disclosure and its associated claims. Further, while the above discussion discloses airbags for individual steps and stairs, behind the riser and/or the horizontal step surface, these airbags may also be placed to the side behind the wall, or to the side behind the side surface of the step.

It is also important to emphasize that the airbags are not deployed indiscriminately once the fall conditions have been detected. Rather, preferably, a computerized device will analyze the fall to project the likely trajectory of the fall and its various points of impact, figure out which cushions need to be deployed at the projected impact location(s) to cushion and/or slow the downward momentum of the fall, and deploy within a fraction of a second, only the cushions needed for this purpose.

FIG. 12 illustrates an airbag-based, fall protection system for an escalator. The general principals of operation are similar to those for a stairway. It is preferable to deploy the airbags units 121 behind the risers 122 of escalators steps 123. When a fall is detected, airbags deploy as with a stairway (including at the base if warranted.) The primary difference over a stairway is that the escalator is moving, and that motion will need to be accounted for in the calculation of the fall trajectory and projected impact area. Because escalator risers are typically made of a metal, an alternate material, such a hard but tearable polymer, will need to be used for the riser in lieu of metallic materials. Additionally, it may be desirable to stop the escalator (gradually, so as to not cause or exacerbate a fall by a sudden lurching) in response to detecting a fall condition.

As noted earlier, environmental sensors (which may be based on optics, video, infrared, radar, (ultra)sound, and any other suitable technology), and in some embodiments supplemented by body-carried sensors, feed raw data into a computerized device which analyzes the patterns sensed by the sensor. Thus, when no accident is about to occur, it will be sensed that the long axis of the person's body is substantially vertical. When an fall is about to occur, the horizontal components of the person's body alignment will increase, and it will be detected that there is a change in this alignment vis-à-vis previously-detected alignments. If the person's foot slips at the edge of a step down to the next lower step to precipitate a fall, then there will be a sudden abrupt change in the vertical location of the person's body based on free fall from one step to the next, rather than continuous controlled downward movement. These, and similar factors as discussed earlier, all are indicators of a fall. Environmental sensors may also be mounted on the stairs themselves to detect weight (pressure). Ordinary ascent and descent from stairs without incident will comprise one pressure profile (fingerprint), whereas abnormal (fall-indicating) descent will comprise a different pressure profile. In some embodiments, also discussed, video cameras coupled to computer vision analysis systems are used for detecting the onset of a fall.

With body-mounted sensors, inertial detectors can signal a fall without necessarily engaging in the type of pattern recognition utilized by the environmental sensors. When a fall is about to occur, a sudden acceleration of the person will be detected, and this acceleration, along with the trajectory gleaned from the sensor, provides the basis for cushion deployment.

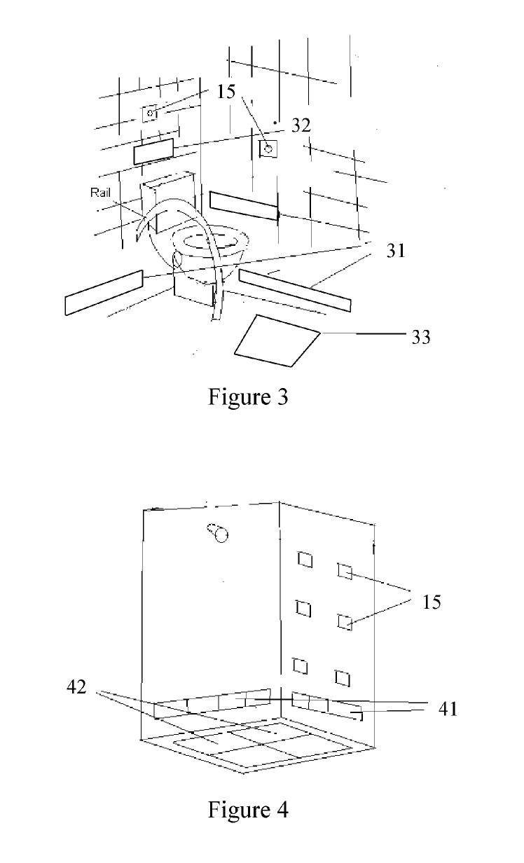

FIG. 3 illustrates a fall protection system for a bathroom. Vertical-(wall-) mounted airbags 31 similar to the airbags 12 mounted behind stair risers 11 are located near the floor, and in other locations, e.g., 32, along the wall. A floor-mounted airbag 33 (or soft/collapsible floor as discussed earlier) is located to provide cushioning emanating from the floor itself. Sensors 15 serve the same function as earlier discussed, namely, detecting fall conditions from the body of a person to be protected, indicating that this person is beginning to fall. This sensing, and the impact projections generated therefrom, are used to deploy whichever airbags are determined to be necessary for the particular fall.

Falls in showers and bathtubs are also very common and very deadly. The combination of a soap and water film typically residing on the floor of the shower or tub, and the person's bare feet supported on that film, create a serious hazard because the coefficient of friction is much lower than that of, say, shoes pressed against a dry floor.

In the shower of FIG. 4, an array of wall-mounted airbags 41 together with an array of floor-mounted cushions 42 (preferably a soft floor) serve to protect against falls in this deadly environment.

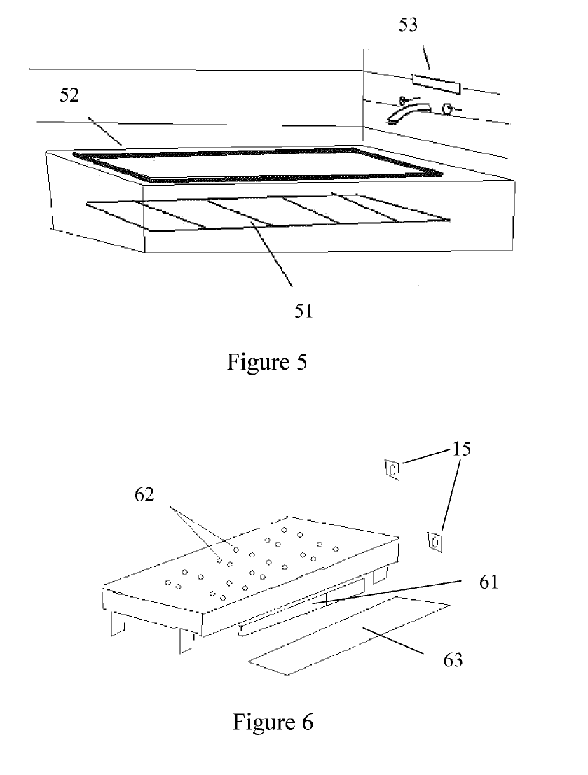

FIG. 5 illustrates an fall protection embodiment for a bathtub. Under the tub floor is a waterproof airbag or array of airbags (or collapsible floor regions overlaid by a durable, waterproof material) with an overlying rubber (or similar) non-slip surface, at 51. A rim-mounted airbag system 52 is mounted about the perimeter of the tub, as illustrated. The tub spigots present a particular danger if a person's head were to strike these during a fall, since these are typically hard and protruding. Thus, a spigot shielding airbag 53 is situated to shield the person to be protected from striking the spigots.

It is also quite frequent that elderly people will fall when getting out of bed. The increase in blood circulation required to go from a lying to a standing position, and the vertigo that accompanies this transition particularly after a night of sleep, even for a younger, healthy person, often causes people rising from bed to fall over. Referring to FIG. 6, under-bed airbags 61 are situated under the bed, behind the vertical rise of the bed frame, and are deployed in response to detecting fall conditions using sensors 15, similarly to the previous discussion. Also illustrated are bed-situated pressure sensors 62 and floor-situated pressure sensors 63. Bed-situated pressure sensors 62 can detect, based on weight and pressure, when a person is trying to get up from bed. In combination with floor-situated pressure sensors 63, and/or sensors 15, it is possible to determine whether the person's rise “signature” is that of a “fall condition” requiring airbag deployment.

In much of the above discussion, we have focused on the use of airbags as the predominant means to cushion a fall. However, there are situations in which airbag deployment can be problematic, and can even introduce its own problems. Certainly, airbags can be used to great effect to cushion a fall from a stairwell (FIGS. 1 and 2). If a person falls from a stairway, and an airbag deploys at the landing of the stairs, that can be very useful to prevent injury or death. Airbags also provide good cushioning against, for example, a person's head hitting a tile wall or a bathroom fixture. But, the use of airbags directly under a floor walking surface can pose a problem if the person is actually walking over those airbags at the time a fall precipitates. That is one reason why, in FIG. 9, we discussed configuring airbags in a grid, and only deploying those airbags at the projected impact location, but not any airbags under the surface actually being walked upon.

An important cushion embodiment noted earlier is known generally as the “soft floor,” or the “collapsible” floor or carpet. The unifying characteristic is that each of these floors essentially undergoes a rapid change in hardness once a fall is detected. During normal use, the floor or carpet remains firm to support walking traffic. But, when a fall is detected, the floor itself changes character, and suddenly decreases in firmness, turning from a walking surface into an effective protective cushion. These collapsible floors can be utilized in many of the places earlier outlined for airbags, and deploy under the same actuation conditions as for airbags, but provide an alternative where the deployment of an airbag might otherwise be problematic in terms of exacerbating rather than softening the fall.

Several kinds of collapsible floor or carpet are illustrated, for example, not limitation. These include: Pneumatic floor or carpet; Spring loaded column; Spring loaded lever column; and Toggle/actuator column system.

A collapsible floor is only for open floor space and should not be used under heavy furniture or objects that could overturn and cause breakage or injury. So in a room, only part of the floor would be collapsible. The parts with heavy furniture would be framed on rigid platforms. The collapsible system would be installed up to and around these areas.

For the pneumatic floor or carpet, in one embodiment, illustrated in FIG. 13, the floor/carpet is made of injection molded plastic tiles, which are supported by inflated pneumatic columns (i.e., one or more pressure cells). The rigidity of the floor is determined by the pressure in the pneumatic column and the tension in cable tie-downs which hold the tiles down with resistant caps. Upon detection of a falling person, air in the bladders is exhausted, and the falling person is cushioned by the collapse of the column formed by the pneumatic chamber and surrounding foam material.

In this FIG. 13 embodiment, the collapsible floor is contained in a carpet-like system, and does not have tiles, but the rigid walking surface is instead maintained by the pneumatic columns that are held in position using cable tie downs to the floor. The cables hold the floor down in a level configuration as the pneumatics push upwards. This embodiment does rely on compressed air and therefore constitutes a stored energy system. To avoid any danger of explosion, systems of relief valves can be provided. If valved together, one relief valve at the supply line may provide over-pressure protection. Or, an approximately ⅛″ or 3/16″ layer of rubber fabric or if need be explosion resistant overlaying carpet may be provided.

Vectran (http://www.vectranfiber.com) and Kevlar are two off-the-shelf fibers with ballistic strength characteristics that could be used. Such systems are already common in home environments in the form of carbonated beverage containers, aerosol cans, paint sprayers, and inflated automobile tires, so there exists in the art off-the-shelf technology that can be employed to ensure safety. In the carpet embodiment, adhesive strips adhere to the floor to provide anchoring force for restraining cables. Alternatively, anchors may be embedded in sub-flooring.

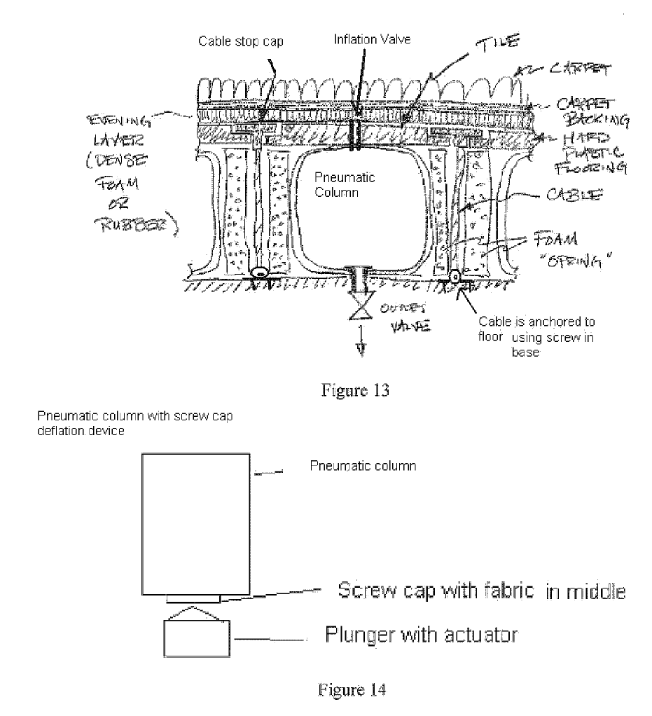

In the pneumatic column embodiment of FIG. 14, a plunger is employed on an actuator to puncture a hole in fabric that is in the middle of screw-cap-type mount to release air pressure. Such a system may also use an electric filament that is sewn into the fabric to burn a hole in the fabric. In this embodiment, after a deployment has occurred, the caregiver or homeowner would need to simply remove the spent cylinders, replace the cap, and re-insert into place. The inflation is done either automatically or by hand. This embodiment presents a less expensive alternative to conventional electromechanical valve systems, where such high capacity release capabilities may not exist or be cost prohibitive. This less expensive system does lack the advantage that would be gained by having an auto-reinflation mode that would not require hand maintenance and that would allow the deployed section of the floor to be returned to its normal surface level.

In a typical embodiment of the collapsible floor of FIG. 13, the pneumatic columns are inflated to support the tiles up against the ends of the restraining cable and are held there by the restraint caps. Upon deflation the load of the faller is only supported by the foam columns. In another embodiment, the load is supported only by the deflating the pneumatic columns and in a third embodiment, the load is supported by a combination of both.

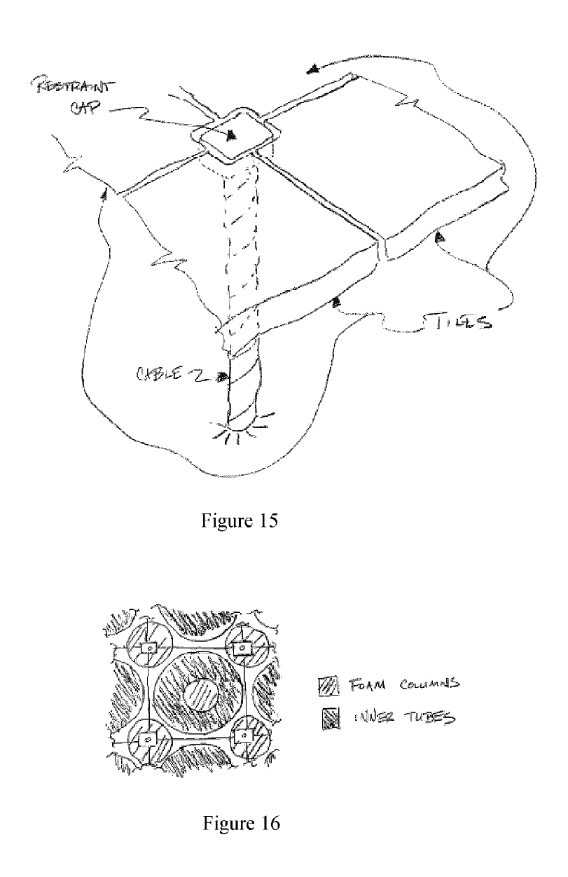

In the embodiment of FIGS. 15 and 16, the rigidity of the floor is controlled by one or more of the following: 1) adjusting air pressure; 2) changing relative areas occupied by pneumatic column versus the foam material; 3) changing the mechanical rigidity or thickness of the tiles; and/or changing the thickness of the carpet overlay.

In one embodiment, for example, not limitation, the floor may be 6-8 inches above the base floor, and the tiles may be about 6×6 inches. They may be injection molded with ribs for stiffness. Because the response time of the floor to change from rigid to cushioning is limited by the time it takes to exhaust air from the pneumatic columns, the speed at which floor reacts could also be increased by connection to a vacuum system or increasing the size of the valves.

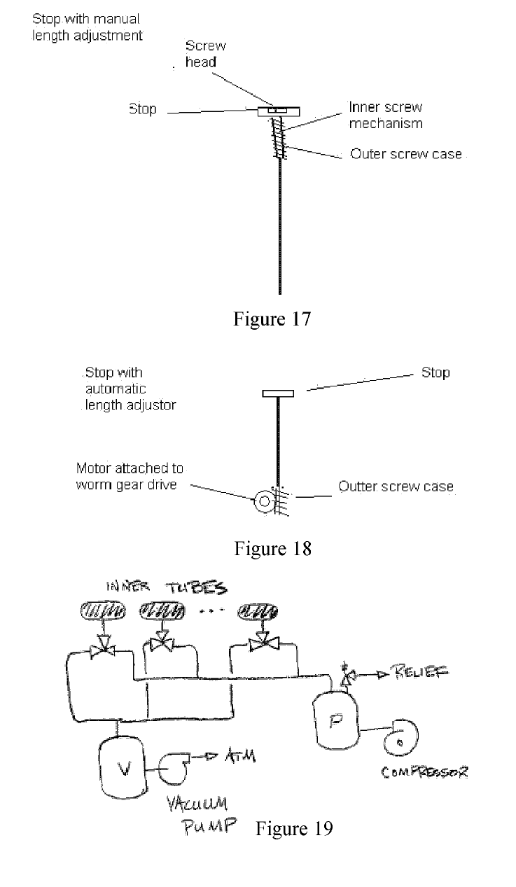

FIGS. 17 and 18 illustrate cables and their stops that supply the restraining force to the top surface (e.g., tile or carpet) which is being forced upward from below by the expanded pneumatic column in one embodiment, or spring activated column in another embodiment. These embodiments supply two means of adjustment to allow the surface to be leveled by the installer or the system. One is manually adjusted, the other uses a motorized system.

In FIG. 19, a centralized air pressure system is used for the pneumatic collapsible floor as described above. The pneumatic columns need to contain enough air pressure to support loads on the surface. In another embodiment, the pressure is supplied by inserting a needle from a hose through a standard Schrader-type inflation valve such as is used on car tires or inflated basketballs, from a portable, handheld air supply. In one embodiment, the procedure is to use a compressed air tank with hose connected to an insertion needle or other inflation connection.

In one embodiment, a mechanically collapsible floor, using a mechanical element rather than air to hold the floor rigid, with a tile/cable-lock system, employs a spring loaded mechanical element to hold tiles up against cable-locks with upward pressure. In a default (no power) state the mechanical support holds the floor in place. In a powered state the mechanical support is collapsed. In another embodiment no cable suspension system is used.

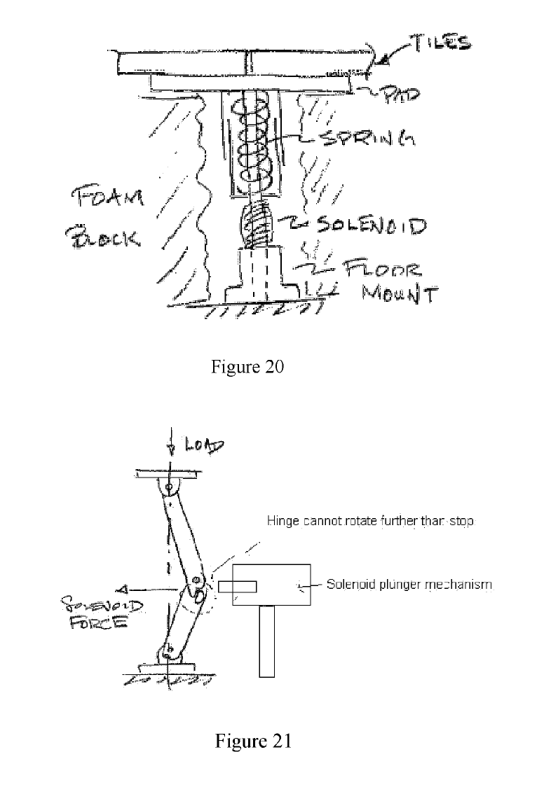

In FIG. 20, a spring loaded column is employed. With the solenoid not actuated, the spring extends and supports the floor. When the solenoid is actuated, it overcomes the spring force, and the spring force support retracts out of the way. The tiles fall onto foam blocks. When solenoid power is removed, the supports again extend to re-rigidize the floor.

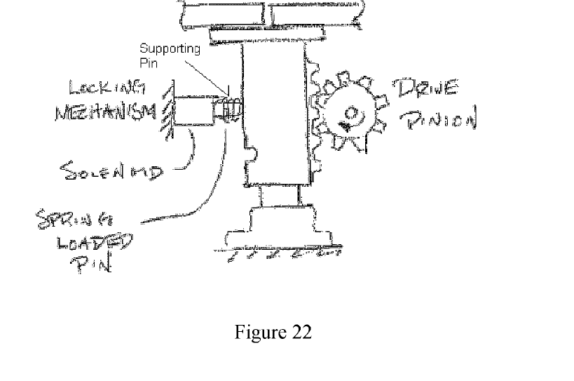

In the embodiments of FIGS. 21-22, a mechanical collapsible floor is employed. FIG. 21 illustrates a hinged, toggle, two-link support. This embodiment uses two links that are hinged together, and both have stops at the joint between them that prevent them from rotating with respect to each other beyond a certain fixed angle (supporting state), similar to a human knee joint. The stops allow the load to be transferred to the underlying floor. When a fall is detected, the associated solenoid plunger mechanism imparts a force to the joint to force it to the opposite side in the vertical direction (unsupporting state). The two links collapse to a lower level, and the above tiles are only supported by cushioning material (e.g., foam).

FIG. 22 illustrates a pin-supported mechanical column support. In this embodiment, a column has gear teeth on one side, a hole to fit the support pin, and a gear drive to drive it into a position to be supported by a mechanically-driven spring loaded pin with solenoid release. When a fall is detected, the solenoid is released, and the pin is removed from the column, no longer locking it. Thus, the column collapses, and tile is left being supported by the cushioning material, e.g., foam.

In all of the soft/collapsible floor embodiments, one employs a floor which under ordinary used is supported by pneumatics or mechanics. Underlying this floor are is a foam or similar cushioning material. When a fall is detected, the support is removed, by releasing the air in a pneumatic system, or by causing the mechanical support to give way for a mechanical system. What remains, therefore, are the cushions underlying the floor. When the person impacts the floor, it is not unlike falling from a standing position on a bed mattress or trampoline. This is in contrast to striking a hard surface, which is to be avoided as a primary object of this invention.

Again, it is to be understood that the enumeration of specific embodiments: for stairways, bathrooms, and bedrooms in no way precludes the application of the disclosures herein to other embodiments, and that other such embodiments are regarded to be within the scope of this disclosure and its associated claims. Similarly, the various collapsible floor embodiments in no way preclude the use other similar structures with similar function, within the scope of this disclosure and its associated claims.

While only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

What is claimed is:

1. A fall protection system comprising:
a sensor;
a computerized device receiving detections from said sensor, for deducing fall conditions from the body of a person to be protected, indicating that said person is beginning to fall; and
at least one cushion not carried with the person, for deployment at at least one projected impact location where it is projected that impact from said fall will occur, for reducing a force of said impact, in response to said detecting fall conditions.

2. The system of claim 1, wherein:
said computerized device deduces said fall conditions by analyzing movement patterns of the person's body and comparing said movement patterns to stored data regarding fall and non-fall movement.

3. The system of claim 2, wherein:
said stored data regarding fall and non-fall movement is machine learning data acquired from tests involving humans.

4. The system of claim 1, wherein:
said sensor is carried with the person.

5. The system of claim 4, wherein:
said computerized device deduces said fall conditions by analyzing inertial data from said sensor regarding movement patterns of the person's body and comparing said movement patterns to stored data regarding fall and non-fall movement.

6. The system of claim 1, said sensor comprising:
an inertial detector for detecting an inertial state of the person's body for said detecting fall conditions.

7. The system of claim 1, wherein:
said sensor is not carried with the person.

8. The system of claim 7, said sensor comprising:
an optical element for optically detecting movement of the person's body for said detecting fall conditions.

9. The system of claim 7, said sensor comprising:
a radar element for radar detecting movement of the person's body for said detecting fall conditions.

10. The system of claim 7, said sensor comprising:
a sonic element for sonically detecting movement of the person's body for said detecting fall conditions.

11. The system of claim 7, said sensor comprising:
an infrared detection element for detecting via infrared emissions, movement of the person's body for said detecting fall conditions.

12. The system of claim 7, said sensor comprising:
a pressure detector for detecting pressure from the person's body for said detecting fall conditions.

13. The system of claim 1, further comprising:
an identifying device carried by said person identifying said person to said system, and basing the cushion deployment on the identity of said person.

14. The system of claim 1, further comprising:
a computerized device for projecting said projected impact location, based on information detected by said sensor.

15. The system of claim claim 14, further comprising:
said computerized device for determining which of the cushions to deploy based on said projecting said projected impact location.

16. The system of claim 1, wherein:
at least one of said cushions, prior to said deployment, is positioned behind a riser of a stairway; and
said cushion deploys by inflating and passing through said riser from behind said riser.

17. The system of claim 16:
said cushion comprising an adhesive for adhering to said person and thereby restraining said fall.

18. system of claim 16:
said cushion comprising a balloon airbag substantially obstructing a descent of said person down said stairway and thereby restraining said fall.

19. The system of claim 1, wherein:
at least one of said cushions, prior to said deployment, is positioned beneath a step of a stairway; and
said cushion deploys by inflating and passing through said step from beneath said step.

20. The system of claim 19:
said cushion comprising an adhesive for adhering to said person and thereby restraining said fall.

21. The system of claim 1, wherein:
at least one of said cushions, prior to said deployment, is positioned beneath a landing of a stairway; and
said cushion deploys by inflating and passing through said landing from beneath said landing.

22. The system of claim 1, wherein:
at least one of said cushions, prior to said deployment, is positioned behind said wall of a stairway; and
said cushion deploys by inflating and passing through said side wall from behind said side wall.

23. The system of claim 1, wherein:
at least one of said cushions, prior to said deployment, is positioned behind a wall of a bathroom; and
said cushion deploys by inflating and passing through said wall from behind said wall.

24. The system of claim 1, wherein:
at least one of said cushions, prior to said deployment, is positioned behind a wall of a shower; and
said cushion deploys by inflating and passing through said wall from behind said wall.

25. The system of claim 1, wherein:
at least one of said cushions, prior to said deployment, is positioned behind a bed frame; and
said cushion deploys by inflating and passing through said bed frame from behind said bed frame.

26. The system of claim 1, said at least one cushion comprising at least one inflatable airbag.

27. The system of claim 1, said at least one cushion comprising a collapsible flooring surface, wherein said surface decreases its hardness in response to said detecting fall conditions.

28. The system of claim 27, said collapsible flooring surface comprising:
pneumatic pressure maintaining said collapsible flooring surface in place during normal use; and
a pressure release mechanism for releasing said pneumatic pressure in response to said detecting fall conditions.

29. The system of claim 27, said collapsible flooring surface comprising:
a pressure housing containing pneumatic pressure for maintaining said collapsible flooring surface in place during normal use; and
a pressure release for releasing said pneumatic pressure in response to said detecting fall conditions.

30. The system of claim 29, wherein said pressure release mechanism creates an opening in said pressure housing, to release said pneumatic pressure.

31. The system of claim 28, further comprising:
a foam material, for supporting said person, once said pneumatic pressure has been released.

32. The system of claim 27, said collapsible flooring surface comprising:
at least one spring maintaining said collapsible flooring surface in place during normal use; and
a spring release for releasing said spring in response to said detecting fall conditions.

33. The system of claim 27, said collapsible flooring surface comprising:
at least one hinged support maintaining said collapsible flooring surface in place during normal use; and
a hinge release mechanism for releasing said hinge in response to said detecting fall conditions.

34. The system of claim 27, said collapsible flooring surface comprising:
at least one pin maintaining said collapsible flooring surface in place during normal use; and
a hinge release mechanism for releasing said pin in response to said detecting fall conditions.

35. A flooring system which changes from a hard state to a cushioned state upon receiving a signal to effectuate said change, comprising:
a floor surface;
a cushioning material beneath said floor surface;
a hard floor support for maintaining said floor in said hard state during normal use; and
a hard floor support release for releasing said at least part of said hard floor support responsive to receiving said signal, such that once said hard floor support is removed, said floor becomes supported by said cushioning material.

36. The system of claim 35, wherein:
said hard floor support comprises pneumatic pressure; and
said hard floor support release comprises a pressure release for releasing said pressure, responsive to said signal.

37. The system of claim 35, wherein:
said hard floor support comprises at least one spring; and
said hard floor support release comprises a spring release for releasing support of said floor by said at least one spring, responsive to said signal.

38. The system of claim 35, wherein:
said hard floor support comprises at least hinged support; and
said hard floor support release comprises a hinge release for releasing the hinge and thereby withdrawing said hard floor support, responsive to said signal.

39. The system of claim 38:
said hinge release comprising at least one pin maintaining said collapsible flooring surface in place during normal use; wherein
said pin is removed to release said hinge.

40. A fall protection method comprising:
receiving detections from a sensor, for deducing fall conditions from the body of a person to be protected, indicating that said person is beginning to fall; and
reducing a force of said impact by deploying at least one cushion not carried with the person, at at least one projected impact location where it is projected that impact from said fall will occur, in response to said detecting fall conditions.

41. The method of claim 40, further comprising:
deducing said fall conditions by analyzing movement patterns of the person's body and comparing said movement patterns to stored data regarding fall and non-fall movement.

42. The method of claim 41, further comprising:
acquiring said stored data regarding fall and non-fall movement as machine learning data, from tests involving humans.

43. The method of claim 40, further comprising:
providing said sensor carried with the person.

44. The method of claim 43, further comprising:
deducing said fall conditions by analyzing inertial data from said sensor regarding movement patterns of the person's body and comparing said movement patterns to stored data regarding fall and non-fall movement.

45. The method of claim 40, further comprising:
detecting an inertial state of the person's body for said detecting fall conditions, using an inertial detector.

46. The method of claim 40, further comprising:
providing said sensor is not carried with the person.

47. The method of claim 46, further comprising:
optically detecting movement of the person's body for said detecting fall conditions.

48. The method of claim 46, further comprising:
radar-detecting movement of the person's body for said detecting fall conditions.

49. The method of claim 46, further comprising:
sonically detecting movement of the person's body for said detecting fall conditions.

50. The method of claim 46, further comprising:
infrared-detecting movement of the person's body for said detecting fall conditions.

51. The method of claim 46, further comprising:
detecting pressure from the person's body for said detecting fall conditions.

52. The method of claim 40, further comprising:
deploying the cushion based on the identity of said person derived from an identifying device carried by said person.

53. The method of claim 40, further comprising:
projecting said projected impact location, based on information detected by said sensor, using a computerized device.

54. The method of claim claim 53, further comprising:
determining which of the cushions to deploy based on said projecting said projected impact location.

55. The method of claim 40, further comprising:
positioning at least one of said cushions, prior to said deployment, behind a riser of a stairway; and
deploying said cushion by inflating and passing said cushion through said riser from behind said riser.

56. The method of claim 55, further comprising:
restraining said fall by adhering said cushion to said person.

57. method of claim 55, further comprising:
substantially obstructing a descent of said person down said stairway and thereby restraining said fall, using said cushion comprising a balloon airbag.

58. The method of claim 40, further comprising:
positioning at least one of said cushions, prior to said deployment, beneath a step of a stairway; and
deploying said cushion by inflating and passing said cushion through said step from beneath said step.

59. The method of claim 58, further comprising:
restraining said fall by adhering said cushion to said person.

60. The method of claim 40, further comprising:
positioning at least one of said cushions, prior to said deployment, beneath a landing of a stairway; and
deploying said cushion by inflating and passing said cushion through said landing from beneath said landing.

61. The method of claim 40, further comprising:
positioning at least one of said cushions, prior to said deployment, behind said wall of a stairway; and
deploying said cushion by inflating and passing said cushion through said side wall from behind said side wall.

62. The method of claim 40, further comprising:
positioning at least one of said cushions, prior to said deployment, behind a wall of a bathroom; and
deploying said cushion by inflating and passing said cushion through said wall from behind said wall.

63. The method of claim 40, further comprising:
positioning at least one of said cushions, prior to said deployment, behind a wall of a shower; and
deploying said cushion deploys by inflating and passing said cushion through said wall from behind said wall.

64. The method of claim 40, further comprising:
positioning at least one of said cushions, prior to said deployment, behind a bed frame; and
deploying said cushion by inflating and passing said cushion through said bed frame from behind said bed frame.

65. The method of claim 40, said at least one cushion comprising at least one inflatable airbag.

66. The method of claim 40, said at least one cushion comprising a collapsible flooring surface, further comprising:
decreasing a hardness of said surface in response to said detecting fall conditions.

67. The method of claim 66, further comprising:
maintaining said collapsible flooring surface in place during normal use using pneumatic pressure; and
releasing said pneumatic pressure in response to said detecting fall conditions.

68. The method of claim 66, further comprising:
maintaining said collapsible flooring surface in place during normal use, using a pressure housing containing pneumatic pressure; and
releasing said pneumatic pressure in response to said detecting fall conditions.

69. The method of claim 68, further comprising:
creating an opening in said pressure housing to release said pneumatic pressure.

70. The method of claim 67, further comprising:
supporting said person, once said pneumatic pressure has been released, using foam material.

71. The method of claim 56, further comprising:
maintaining said collapsible flooring surface in place during normal use, using at least one spring; and
releasing said spring in response to said detecting fall conditions.

72. The method of claim 56, further comprising:
maintaining said collapsible flooring surface in place during normal use, using at least one hinged support; and
releasing said hinge in response to said detecting fall conditions.

73. The method of claim 56, further comprising:
maintaining said collapsible flooring surface in place during normal use, using at least one pin; and
releasing said pin in response to said detecting fall conditions.

74. A method for changing a flooring system from a hard state to a cushioned state upon receiving a signal to effectuate said change, comprising:
providing a cushioning material beneath a floor surface;
maintaining said floor in said hard state during normal use, using a hard floor support;
releasing said at least part of said hard floor support responsive to receiving said signal; and
once said hard floor support is removed, supporting said floor by said cushioning material.

75. The method of claim 74, wherein said hard floor support comprises pneumatic pressure; further comprising:
releasing said pressure from hard floor support, responsive to said signal.

76. The method of claim 74, wherein said hard floor support comprises at least one spring; further comprising:
releasing said hard floor support by releasing said spring, responsive to said signal.

77. The method of claim 74, wherein said hard floor support comprises at least hinged support; further comprising:
releasing said hard floor support by releasing the hinge, responsive to said signal.

78. The method of claim 77, wherein said hinge release comprises at least one pin maintaining said collapsible flooring surface in place during normal use; further comprising:
removing said pin to release said hinge.
